(19) United States
(12) Patent Application Publication
(10) Pub. No.: US 2026/0147577 A1
(43) Pub. Date: May 28, 2026

(54) Apparatus and Method for Efficient Matrix Processing in a Clustered Processor Core

(71) Applicant: Intel Corporation, Santa Clara, CA (US)

(72) Inventors: Ching-Kai LIANG, Beaverton, OR (US); Roger GRAMUNT, Portland, OR (US)

(21) Appl. No.: 18/957,551

(22) Filed: Nov. 22, 2024

(51) Int. Cl. G06F 9/38; G06F 9/30

(52) U.S. Cl. CPC G06F 9/3856; G06F 9/3013; G06F 9/3802

(57) ABSTRACT

An apparatus and method for efficient matrix processing in a clustered processor core. For example, one embodiment of a processor comprises: a front end to fetch and decode a plurality of instruction strands to generate a corresponding plurality of microoperations, including matrix processing microoperations; a reservation station to schedule the microoperations for execution in accordance with a first scheduling mode; out-of-order execution circuitry to execute the microoperations; and a detector to determine a density of the matrix processing microoperations within an interval and to signal to the reservation station to implement a second scheduling mode when the density of matrix processing microoperations reaches or exceeds a first threshold.

### BACKGROUND

### Field of the Invention

This invention relates generally to the field of computer processors. More particularly, the invention relates to an apparatus and method for efficient matrix processing in a clustered processor core.

### Description of the Related Art

General Matrix Multiply (GeMM) kernels are a fundamental operation in high performance computing (HPC) and artificial intelligence (AI) workloads which typically have a high-degree of instruction level parallelism (ILP) in a short sequence of instructions, but very little ILP over a long sequence of instructions. When running on a clustered processor core, these workload characteristics would result in serializing execution on a single cluster, which would severely limit the achievable performance.

### BRIEF DESCRIPTION OF THE DRAWINGS

A better understanding of the present invention can be obtained from the following detailed description in conjunction with the following drawings, in which:

FIG. 1 illustrates an example computer system architecture.

FIG. 2 illustrates a processor comprising a plurality of cores.

FIG. 3A illustrates a plurality of stages of a processing pipeline.

FIG. 3B illustrates details of one embodiment of a core.

FIG. 4 illustrates execution circuitry in accordance with one embodiment.

FIG. 5 illustrates one embodiment of a register architecture.

FIG. 6 illustrates one example of an instruction format.

FIG. 7 illustrates addressing techniques in accordance with one embodiment.

FIG. 8 illustrates one embodiment of an instruction prefix.

FIGS. 9A-D illustrate embodiments of how the R, X, and B fields of the prefix are used.

FIGS. 10A-B illustrate examples of a second instruction prefix.

FIG. 11 illustrates payload bytes of one embodiment of an instruction prefix.

FIG. 12 illustrates instruction conversion and binary translation implementations.

FIG. 13 illustrates a processor architecture in accordance with some embodiments of the invention.

FIGS. 14-15 illustrate different examples of tensor operations circuitry coupled to a processor and memory.

FIG. 16 illustrates an example architecture including a matrix operations detector.

FIG. 17 illustrates a method in accordance with some embodiments of the invention.

FIG. 18 illustrates a set of vector registers and execution circuitry for executing a matrix multiplication instruction.

FIGS. 19-21 illustrate example operations performed with a first matrix operand and a second matrix operand to generate a result matrix.

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

### Exemplary Computer Architectures

Detailed below are describes of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

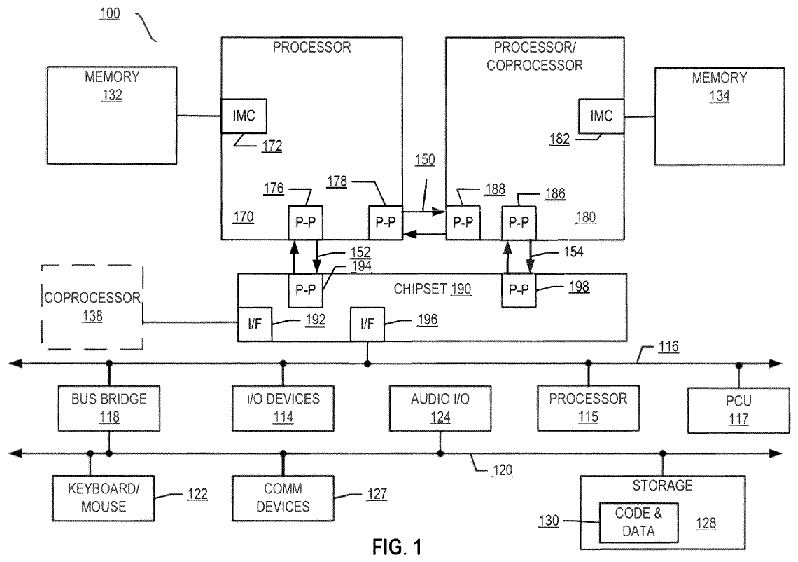

FIG. 1 illustrates embodiments of an exemplary system. Multiprocessor system 100 is a point-to-point interconnect system and includes a plurality of processors including a first processor 170 and a second processor 180 coupled via a point-to-point interconnect 150. In some embodiments, the first processor 170 and the second processor 180 are homogeneous. In some embodiments, first processor 170 and the second processor 180 are heterogenous.

Processors 170 and 180 are shown including integrated memory controller (IMC) units circuitry 172 and 182, respectively. Processor 170 also includes as part of its interconnect controller units point-to-point (P-P) interfaces 176 and 178; similarly, second processor 180 includes P-P interfaces 186 and 188. Processors 170, 180 may exchange information via the point-to-point (P-P) interconnect 150 using P-P interface circuits 178, 188. IMCs 172 and 182 couple the processors 170, 180 to respective memories, namely a memory 132 and a memory 134, which may be portions of main memory locally attached to the respective processors.

Processors 170, 180 may each exchange information with a chipset 190 via individual P-P interconnects 152, 154 using point to point interface circuits 176, 194, 186, 198. Chipset 190 may optionally exchange information with a coprocessor 138 via a high-performance interface 192. In some embodiments, the coprocessor 138 is a special-purpose processor, such as, for example, a high-throughput MIC processor, a network or communication processor, compression engine, graphics processor, GPGPU, embedded processor, or the like.

A shared cache (not shown) may be included in either processor 170, 180 or outside of both processors, yet connected with the processors via P-P interconnect, such that either or both processors' local cache information may be stored in the shared cache if a processor is placed into a low power mode.

Chipset 190 may be coupled to a first interconnect 116 via an interface 196. In some embodiments, first interconnect 116 may be a Peripheral Component Interconnect (PCI) interconnect, or an interconnect such as a PCI Express interconnect or another I/O interconnect. In some embodiments, one of the interconnects couples to a power control unit (PCU) 117, which may include circuitry, software, and/or firmware to perform power management operations with regard to the processors 170, 180 and/or co-processor 138. PCU 117 provides control information to a voltage regulator to cause the voltage regulator to generate the appropriate regulated voltage. PCU 117 also provides control information to control the operating voltage generated. In various embodiments, PCU 117 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 117 is illustrated as being present as logic separate from the processor 170 and/or processor 180. In other cases, PCU 117 may execute on a given one or more of cores (not shown) of processor 170 or 180. In some cases, PCU 117 may be implemented as a microcontroller (dedicated or general-purpose) or other control logic configured to execute its own dedicated power management code, sometimes referred to as P-code. In yet other embodiments, power management operations to be performed by PCU 117 may be implemented externally to a processor, such as by way of a separate power management integrated circuit (PMIC) or another component external to the processor. In yet other embodiments, power management operations to be performed by PCU 117 may be implemented within BIOS or other system software.

Various I/O devices 114 may be coupled to first interconnect 116, along with an interconnect (bus) bridge 118 which couples first interconnect 116 to a second interconnect 120. In some embodiments, one or more additional processor(s) 115, such as coprocessors, high-throughput MIC processors, GPGPU's, accelerators (such as, e.g., graphics accelerators or digital signal processing (DSP) units), field programmable gate arrays (FPGAs), or any other processor, are coupled to first interconnect 116. In some embodiments, second interconnect 120 may be a low pin count (LPC) interconnect. Various devices may be coupled to second interconnect 120 including, for example, a keyboard and/or mouse 122, communication devices 127 and a storage unit circuitry 128. Storage unit circuitry 128 may be a disk drive or other mass storage device which may include instructions/code and data 130, in some embodiments. Further, an audio I/O 124 may be coupled to second interconnect 120. Note that other architectures than the point-to-point architecture described above are possible. For example, instead of the point-to-point architecture, a system such as multiprocessor system 100 may implement a multi-drop interconnect or other such architecture.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die as the described CPU (sometimes referred to as the application core(s) or application processor(s)), the above described coprocessor, and additional functionality. Exemplary core architectures are described next, followed by descriptions of exemplary processors and computer architectures.

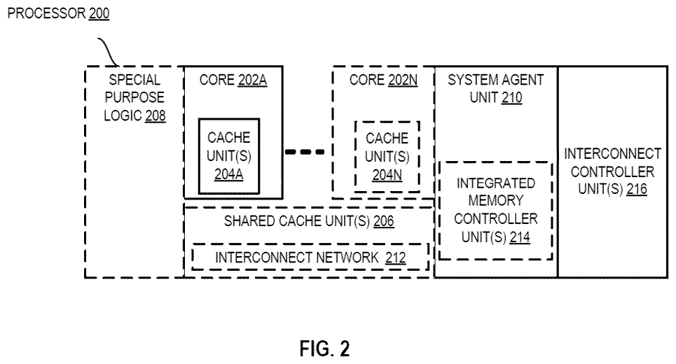

FIG. 2 illustrates a block diagram of embodiments of a processor 200 that may have more than one core, may have an integrated memory controller, and may have integrated graphics. The solid lined boxes illustrate a processor 200 with a single core 202A, a system agent 210, a set of one or more interconnect controller units circuitry 216, while the optional addition of the dashed lined boxes illustrates an alternative processor 200 with multiple cores 202(A)-(N), a set of one or more integrated memory controller unit(s) circuitry 214 in the system agent unit circuitry 210, and special purpose logic 208, as well as a set of one or more interconnect controller units circuitry 216. Note that the processor 200 may be one of the processors 170 or 180, or co-processor 138 or 115 of FIG. 1.

Thus, different implementations of the processor 200 may include: 1) a CPU with the special purpose logic 208 being integrated graphics and/or scientific (throughput) logic (which may include one or more cores, not shown), and the cores 202(A)-(N) being one or more general purpose cores (e.g., general purpose in-order cores, general purpose out-of-order cores, or a combination of the two); 2) a coprocessor with the cores 202(A)-(N) being a large number of special purpose cores intended primarily for graphics and/or scientific (throughput); and 3) a coprocessor with the cores 202(A)-(N) being a large number of general purpose in-order cores. Thus, the processor 200 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 200 may be a part of and/or may be implemented on one or more substrates using any of a number of process technologies, such as, for example, BiCMOS, CMOS, or NMOS.

A memory hierarchy includes one or more levels of cache unit(s) circuitry 204(A)-(N) within the cores 202(A)-(N), a set of one or more shared cache units circuitry 206, and external memory (not shown) coupled to the set of integrated memory controller units circuitry 214. The set of one or more shared cache units circuitry 206 may include one or more mid-level caches, such as level 2 (L2), level 3 (L3), level 4 (L4), or other levels of cache, such as a last level cache (LLC), and/or combinations thereof. While in some embodiments ring-based interconnect network circuitry 212 interconnects the special purpose logic 208 (e.g., integrated graphics logic), the set of shared cache units circuitry 206, and the system agent unit circuitry 210, alternative embodiments use any number of well-known techniques for interconnecting such units. In some embodiments, coherency is maintained between one or more of the shared cache units circuitry 206 and cores 202(A)-(N).

In some embodiments, one or more of the cores 202(A)-(N) are capable of multi-threading. The system agent unit circuitry 210 includes those components coordinating and operating cores 202(A)-(N). The system agent unit circuitry 210 may include, for example, power control unit (PCU) circuitry and/or display unit circuitry (not shown). The PCU may be or may include logic and components needed for regulating the power state of the cores 202(A)-(N) and/or the special purpose logic 208 (e.g., integrated graphics logic). The display unit circuitry is for driving one or more externally connected displays.

The cores 202(A)-(N) may be homogenous or heterogeneous in terms of architecture instruction set; that is, two or more of the cores 202(A)-(N) may be capable of executing the same instruction set, while other cores may be capable of executing only a subset of that instruction set or a different instruction set.

### Exemplary Core Architectures

### In-Order and Out-of-Order Core Block Diagram

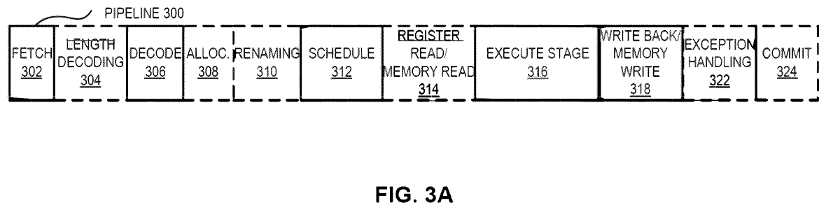

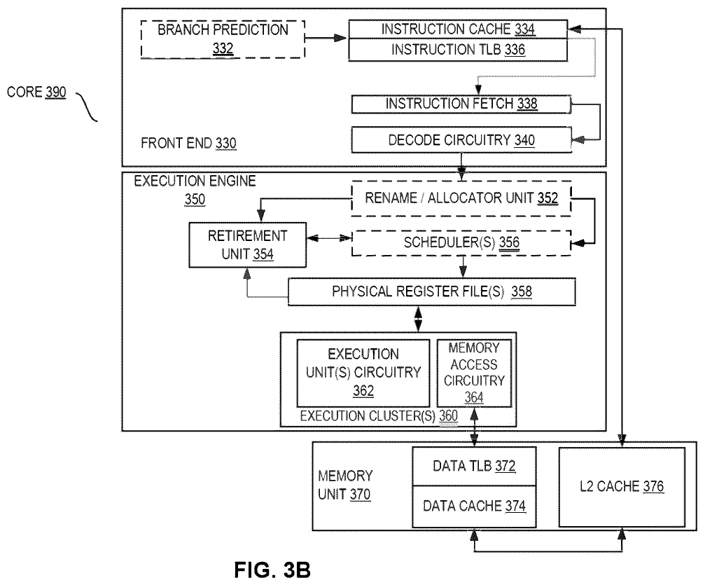

FIG. 3(A) is a block diagram illustrating both an exemplary in-order pipeline and an exemplary register renaming, out-of-order issue/execution pipeline according to embodiments of the invention. FIG. 3(B) is a block diagram illustrating both an exemplary embodiment of an in-order architecture core and an exemplary register renaming, out-of-order issue/execution architecture core to be included in a processor according to embodiments of the invention. The solid lined boxes in FIGS. 3(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 3(A), a processor pipeline 300 includes a fetch stage 302, an optional length decode stage 304, a decode stage 306, an optional allocation stage 308, an optional renaming stage 310, a scheduling (also known as a dispatch or issue) stage 312, an optional register read/memory read stage 314, an execute stage 316, a write back/memory write stage 318, an optional exception handling stage 322, and an optional commit stage 324. One or more operations can be performed in each of these processor pipeline stages. For example, during the fetch stage 302, one or more instructions are fetched from instruction memory, during the decode stage 306, the one or more fetched instructions may be decoded, addresses (e.g., load store unit (LSU) addresses) using forwarded register ports may be generated, and branch forwarding (e.g., immediate offset or an link register (LR)) may be performed. In one embodiment, the decode stage 306 and the register read/memory read stage 314 may be combined into one pipeline stage. In one embodiment, during the execute stage 316, the decoded instructions may be executed, LSU address/data pipelining to an Advanced Microcontroller Bus (AHB) interface may be performed, multiply and add operations may be performed, arithmetic operations with branch results may be performed, etc.

By way of example, the exemplary register renaming, out-of-order issue/execution core architecture may implement the pipeline 300 as follows: 1) the instruction fetch 338 performs the fetch and length decoding stages 302 and 304; 2) the decode unit circuitry 340 performs the decode stage 306; 3) the rename/allocator unit circuitry 352 performs the allocation stage 308 and renaming stage 310; 4) the scheduler unit(s) circuitry 356 performs the schedule stage 312; 5) the physical register file(s) unit(s) circuitry 358 and the memory unit circuitry 370 perform the register read/memory read stage 314; the execution cluster 360 perform the execute stage 316; 6) the memory unit circuitry 370 and the physical register file(s) unit(s) circuitry 358 perform the write back/memory write stage 318; 7) various units (unit circuitry) may be involved in the exception handling stage 322; and 8) the retirement unit circuitry 354 and the physical register file(s) unit(s) circuitry 358 perform the commit stage 324.

FIG. 3(B) shows processor core 390 including front-end unit circuitry 330 coupled to an execution engine unit circuitry 350, and both are coupled to a memory unit circuitry 370. The core 390 may be a reduced instruction set computing (RISC) core, a complex instruction set computing (CISC) core, a very long instruction word (VLIW) core, or a hybrid or alternative core type. As yet another option, the core 390 may be a special-purpose core, such as, for example, a network or communication core, compression engine, coprocessor core, general purpose computing graphics processing unit (GPGPU) core, graphics core, or the like.

The front end unit circuitry 330 may include branch prediction unit circuitry 332 coupled to an instruction cache unit circuitry 334, which is coupled to an instruction translation lookaside buffer (TLB) 336, which is coupled to instruction fetch unit circuitry 338, which is coupled to decode unit circuitry 340. In one embodiment, the instruction cache unit circuitry 334 is included in the memory unit circuitry 370 rather than the front-end unit circuitry 330. The decode unit circuitry 340 (or decoder) may decode instructions, and generate as an output one or more micro-operations, micro-code entry points, microinstructions, other instructions, or other control signals, which are decoded from, or which otherwise reflect, or are derived from, the original instructions. The decode unit circuitry 340 may further include an address generation unit circuitry (AGU, not shown). In one embodiment, the AGU generates an LSU address using forwarded register ports, and may further perform branch forwarding (e.g., immediate offset branch forwarding, LR register branch forwarding, etc.). The decode unit circuitry 340 may be implemented using various different mechanisms. Examples of suitable mechanisms include, but are not limited to, look-up tables, hardware implementations, programmable logic arrays (PLAs), microcode read only memories (ROMs), etc. In one embodiment, the core 390 includes a microcode ROM (not shown) or other medium that stores microcode for certain macroinstructions (e.g., in decode unit circuitry 340 or otherwise within the front end unit circuitry 330). In one embodiment, the decode unit circuitry 340 includes a micro-operation (micro-op) or operation cache (not shown) to hold/cache decoded operations, micro-tags, or micro-operations generated during the decode or other stages of the processor pipeline 300. The decode unit circuitry 340 may be coupled to rename/allocator unit circuitry 352 in the execution engine unit circuitry 350.

The execution engine circuitry 350 includes the rename/allocator unit circuitry 352 coupled to a retirement unit circuitry 354 and a set of one or more scheduler(s) circuitry 356. The scheduler(s) circuitry 356 represents any number of different schedulers, including reservations stations, central instruction window, etc. In some embodiments, the scheduler(s) circuitry 356 can include arithmetic logic unit (ALU) scheduler/scheduling circuitry, ALU queues, arithmetic generation unit (AGU) scheduler/scheduling circuitry, AGU queues, etc. The scheduler(s) circuitry 356 is coupled to the physical register file(s) circuitry 358. Each of the physical register file(s) circuitry 358 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one embodiment, the physical register file(s) unit circuitry 358 includes vector registers unit circuitry, writemask registers unit circuitry, and scalar register unit circuitry. These register units may provide architectural vector registers, vector mask registers, general-purpose registers, etc. The physical register file(s) unit(s) circuitry 358 is overlapped by the retirement unit circuitry 354 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 354 and the physical register file(s) circuitry 358 are coupled to the execution cluster(s) 360. The execution cluster(s) 360 includes a set of one or more execution units circuitry 362 and a set of one or more memory access circuitry 364. The execution units circuitry 362 may perform various arithmetic, logic, floating-point or other types of operations (e.g., shifts, addition, subtraction, multiplication) and on various types of data (e.g., scalar floating-point, packed integer, packed floating-point, vector integer, vector floating-point). While some embodiments may include a number of execution units or execution unit circuitry dedicated to specific functions or sets of functions, other embodiments may include only one execution unit circuitry or multiple execution units/execution unit circuitry that all perform all functions. The scheduler(s) circuitry 356, physical register file(s) unit(s) circuitry 358, and execution cluster(s) 360 are shown as being possibly plural because certain embodiments create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) unit circuitry, and/or execution cluster—and in the case of a separate memory access pipeline, certain embodiments are implemented in which only the execution cluster of this pipeline has the memory access unit(s) circuitry 364). It should also be understood that where separate pipelines are used, one or more of these pipelines may be out-of-order issue/execution and the rest in-order.

In some embodiments, the execution engine unit circuitry 350 may perform load store unit (LSU) address/data pipelining to an Advanced Microcontroller Bus (AHB) interface (not shown), and address phase and writeback, data phase load, store, and branches.

The set of memory access circuitry 364 is coupled to the memory unit circuitry 370, which includes data TLB unit circuitry 372 coupled to a data cache circuitry 374 coupled to a level 2 (L2) cache circuitry 376. In one exemplary embodiment, the memory access units circuitry 364 may include a load unit circuitry, a store address unit circuit, and a store data unit circuitry, each of which is coupled to the data TLB circuitry 372 in the memory unit circuitry 370. The instruction cache circuitry 334 is further coupled to a level 2 (L2) cache unit circuitry 376 in the memory unit circuitry 370. In one embodiment, the instruction cache 334 and the data cache 374 are combined into a single instruction and data cache (not shown) in L2 cache unit circuitry 376, a level 3 (L3) cache unit circuitry (not shown), and/or main memory. The L2 cache unit circuitry 376 is coupled to one or more other levels of cache and eventually to a main memory.

The core 390 may support one or more instructions sets (e.g., the x86 instruction set (with some extensions that have been added with newer versions); the MIPS instruction set; the ARM instruction set (with optional additional extensions such as NEON)), including the instruction(s) described herein. In one embodiment, the core 390 includes logic to support a packed data instruction set extension (e.g., AVX1, AVX2), thereby allowing the operations used by many multimedia applications to be performed using packed data.

### Exemplary Execution Unit(s) Circuitry

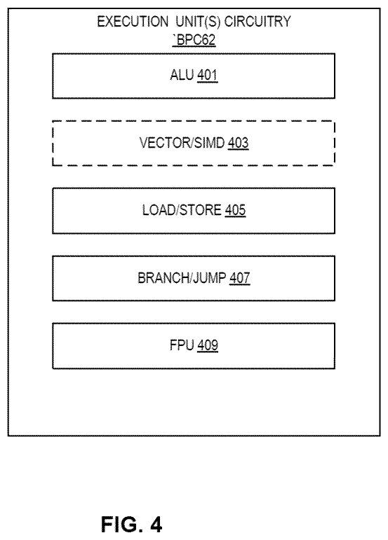

FIG. 4 illustrates embodiments of execution unit(s) circuitry, such as execution unit(s) circuitry 362 of FIG. 3(B). As illustrated, execution unit(s) circuitry 362 may include one or more ALU circuits 401, vector/SIMD unit circuits 403, load/store unit circuits 405, and/or branch/jump unit circuits 407. ALU circuits 401 perform integer arithmetic and/or Boolean operations. Vector/SIMD unit circuits 403 perform vector/SIMD operations on packed data (such as SIMD/vector registers). Load/store unit circuits 405 execute load and store instructions to load data from memory into registers or store from registers to memory. Load/store unit circuits 405 may also generate addresses. Branch/jump unit circuits 407 cause a branch or jump to a memory address depending on the instruction. Floating-point unit (FPU) circuits 409 perform floating-point arithmetic. The width of the execution unit(s) circuitry 362 varies depending upon the embodiment and can range from 16-bit to 1,024-bit. In some embodiments, two or more smaller execution units are logically combined to form a larger execution unit (e.g., two 128-bit execution units are logically combined to form a 256-bit execution unit).

### Exemplary Register Architecture

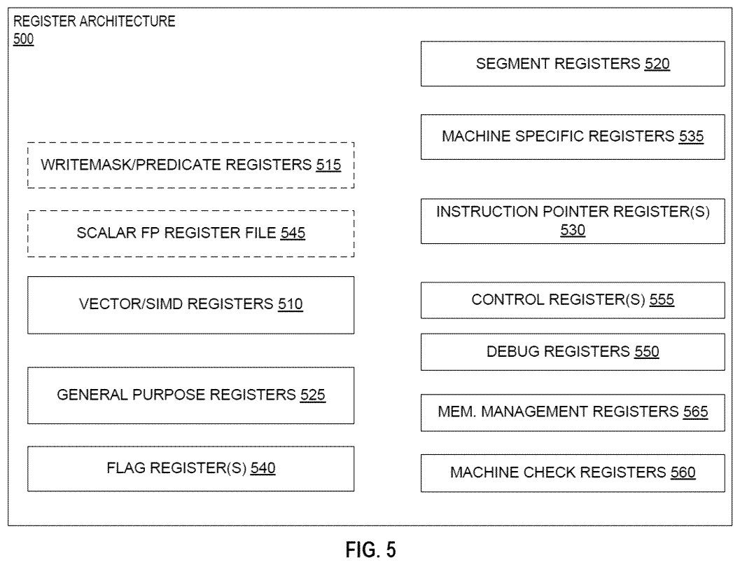

FIG. 5 is a block diagram of a register architecture 500 according to some embodiments. As illustrated, there are vector/SIMD registers 510 that vary from 128-bit to 1,024 bits width. In some embodiments, the vector/SIMD registers 510 are physically 512-bits and, depending upon the mapping, only some of the lower bits are used. For example, in some embodiments, the vector/SIMD registers 510 are ZMM registers which are 512 bits: the lower 256 bits are used for YMM registers and the lower 128 bits are used for XMM registers. As such, there is an overlay of registers. In some embodiments, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the embodiment.

In some embodiments, the register architecture 500 includes writemask/predicate registers 515. For example, in some embodiments, there are 8 writemask/predicate registers (sometimes called k0 through k7) that are each 16-bit, 32-bit, 64-bit, or 128-bit in size. Writemask/predicate registers 515 may allow for merging (e.g., allowing any set of elements in the destination to be protected from updates during the execution of any operation) and/or zeroing (e.g., zeroing vector masks allow any set of elements in the destination to be zeroed during the execution of any operation). In some embodiments, each data element position in a given writemask/predicate register 515 corresponds to a data element position of the destination. In other embodiments, the writemask/predicate registers 515 are scalable and consists of a set number of enable bits for a given vector element (e.g., 8 enable bits per 64-bit vector element).

The register architecture 500 includes a plurality of general-purpose registers 525. These registers may be 16-bit, 32-bit, 64-bit, etc. and can be used for scalar operations. In some embodiments, these registers are referenced by the names RAX, RBX, RCX, RDX, RBP, RSI, RDI, RSP, and R8 through R15.

In some embodiments, the register architecture 500 includes scalar floating-point register 545 which is used for scalar floating-point operations on 32/64/80-bit floating-point data using the x87 instruction set extension or as MMX registers to perform operations on 64-bit packed integer data, as well as to hold operands for some operations performed between the MMX and XMM registers.

One or more flag registers 540 (e.g., EFLAGS, RFLAGS, etc.) store status and control information for arithmetic, compare, and system operations. For example, the one or more flag registers 540 may store condition code information such as carry, parity, auxiliary carry, zero, sign, and overflow. In some embodiments, the one or more flag registers 540 are called program status and control registers.

Segment registers 520 contain segment points for use in accessing memory. In some embodiments, these registers are referenced by the names CS, DS, SS, ES, FS, and GS.

Machine specific registers (MSRs) 535 control and report on processor performance. Most MSRs 535 handle system-related functions and are not accessible to an application program. Machine check registers 560 consist of control, status, and error reporting MSRs that are used to detect and report on hardware errors.

One or more instruction pointer register(s) 530 store an instruction pointer value. Control register(s) 555 (e.g., CR0-CR4) determine the operating mode of a processor (e.g., processor 170, 180, 138, 115, and/or 200) and the characteristics of a currently executing task. Debug registers 550 control and allow for the monitoring of a processor or core's debugging operations.

Memory management registers 565 specify the locations of data structures used in protected mode memory management. These registers may include a GDTR, IDRT, task register, and a LDTR register.

Alternative embodiments of the invention may use wider or narrower registers. Additionally, alternative embodiments of the invention may use more, less, or different register files and registers.

### Instruction Sets

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands.

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

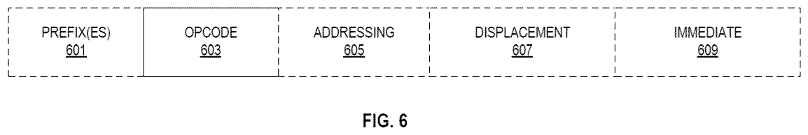

FIG. 6 illustrates embodiments of an instruction format. As illustrated, an instruction may include multiple components including, but not limited to, one or more fields for: one or more prefixes 601, an opcode 603, addressing information 605 (e.g., register identifiers, memory addressing information, etc.), a displacement value 607, and/or an immediate 609. Note that some instructions utilize some or all of the fields of the format whereas others may only use the field for the opcode 603. In some embodiments, the order illustrated is the order in which these fields are to be encoded, however, it should be appreciated that in other embodiments these fields may be encoded in a different order, combined, etc.

The prefix(es) field(s) 601, when used, modifies an instruction. In some embodiments, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 603 is used to at least partially define the operation to be performed upon a decoding of the instruction. In some embodiments, a primary opcode encoded in the opcode field 603 is 1, 2, or 3 bytes in length. In other embodiments, a primary opcode can be a different length. An additional 3-bit opcode field is sometimes encoded in another field.

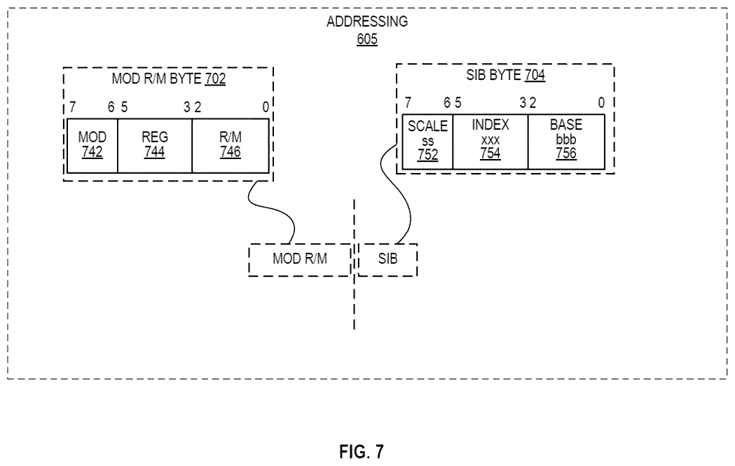

The addressing field 605 is used to address one or more operands of the instruction, such as a location in memory or one or more registers. FIG. 7 illustrates embodiments of the addressing field 605. In this illustration, an optional ModR/M byte 702 and an optional Scale, Index, Base (SIB) byte 704 are shown. The ModR/M byte 702 and the SIB byte 704 are used to encode up to two operands of an instruction, each of which is a direct register or effective memory address. Note that each of these fields are optional in that not all instructions include one or more of these fields. The MOD R/M byte 702 includes a MOD field 742, a register field 744, and R/M field 746.

The content of the MOD field 742 distinguishes between memory access and non-memory access modes. In some embodiments, when the MOD field 742 has a value of b11, a register-direct addressing mode is utilized, and otherwise register-indirect addressing is used.

The register field 744 may encode either the destination register operand or a source register operand, or may encode an opcode extension and not be used to encode any instruction operand. The content of register index field 744, directly or through address generation, specifies the locations of a source or destination operand (either in a register or in memory). In some embodiments, the register field 744 is supplemented with an additional bit from a prefix (e.g., prefix 601) to allow for greater addressing.

The R/M field 746 may be used to encode an instruction operand that references a memory address, or may be used to encode either the destination register operand or a source register operand. Note the R/M field 746 may be combined with the MOD field 742 to dictate an addressing mode in some embodiments.

The SIB byte 704 includes a scale field 752, an index field 754, and a base field 756 to be used in the generation of an address. The scale field 752 indicates scaling factor. The index field 754 specifies an index register to use. In some embodiments, the index field 754 is supplemented with an additional bit from a prefix (e.g., prefix 601) to allow for greater addressing. The base field 756 specifies a base register to use. In some embodiments, the base field 756 is supplemented with an additional bit from a prefix (e.g., prefix 601) to allow for greater addressing. In practice, the content of the scale field 752 allows for the scaling of the content of the index field 754 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some embodiments, a displacement field 607 provides this value. Additionally, in some embodiments, a displacement factor usage is encoded in the MOD field of the addressing field 605 that indicates a compressed displacement scheme for which a displacement value is calculated by multiplying disp8 in conjunction with a scaling factor N that is determined based on the vector length, the value of a b bit, and the input element size of the instruction. The displacement value is stored in the displacement field 607.

In some embodiments, an immediate field 609 specifies an immediate for the instruction. An immediate may be encoded as a 1-byte value, a 2-byte value, a 4-byte value, etc.

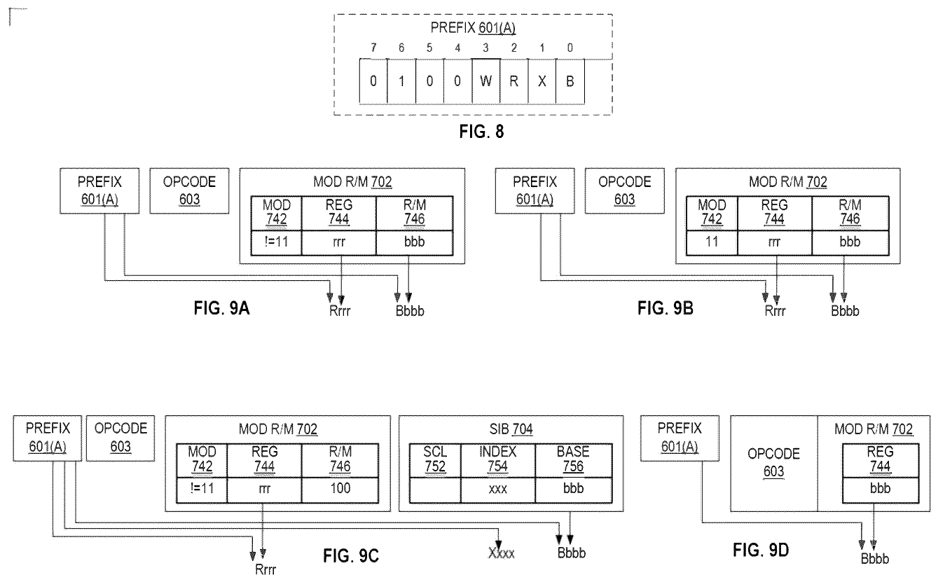

FIG. 8 illustrates embodiments of a first prefix 601(A). In some embodiments, the first prefix 601(A) is an embodiment of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 601(A) may specify up to three registers using 3-bit fields depending on the format: 1) using the reg field 744 and the R/M field 746 of the Mod R/M byte 702; 2) using the Mod R/M byte 702 with the SIB byte 704 including using the reg field 744 and the base field 756 and index field 754; or 3) using the register field of an opcode.

In the first prefix 601(A), bit positions 7:4 are set as 0100. Bit position 3 (W) can be used to determine the operand size, but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 744 and MOD R/M R/M field 746 alone can each only address 8 registers.

In the first prefix 601(A), bit position 2 (R) may an extension of the MOD R/M reg field 744 and may be used to modify the ModR/M reg field 744 when that field encodes a general purpose register, a 64-bit packed data register (e.g., a SSE register), or a control or debug register. R is ignored when Mod R/M byte 702 specifies other registers or defines an extended opcode.

Bit position 1 (X) X bit may modify the SIB byte index field 754.

Bit position B (B) B may modify the base in the Mod R/M R/M field 746 or the SIB byte base field 756; or it may modify the opcode register field used for accessing general purpose registers (e.g., general purpose registers 525).

FIGS. 9(A)-(D) illustrate embodiments of how the R, X, and B fields of the first prefix 601(A) are used. FIG. 9(A) illustrates R and B from the first prefix 601(A) being used to extend the reg field 744 and R/M field 746 of the MOD R/M byte 702 when the SIB byte 704 is not used for memory addressing. FIG. 9(B) illustrates R and B from the first prefix 601(A) being used to extend the reg field 744 and R/M field 746 of the MOD R/M byte 702 when the SIB byte 704 is not used (register-register addressing). FIG. 9(C) illustrates R, X, and B from the first prefix 601(A) being used to extend the reg field 744 of the MOD R/M byte 702 and the index field 754 and base field 756 when the SIB byte 704 being used for memory addressing. FIG. 9(D) illustrates B from the first prefix 601(A) being used to extend the reg field 744 of the MOD R/M byte 702 when a register is encoded in the opcode 603.

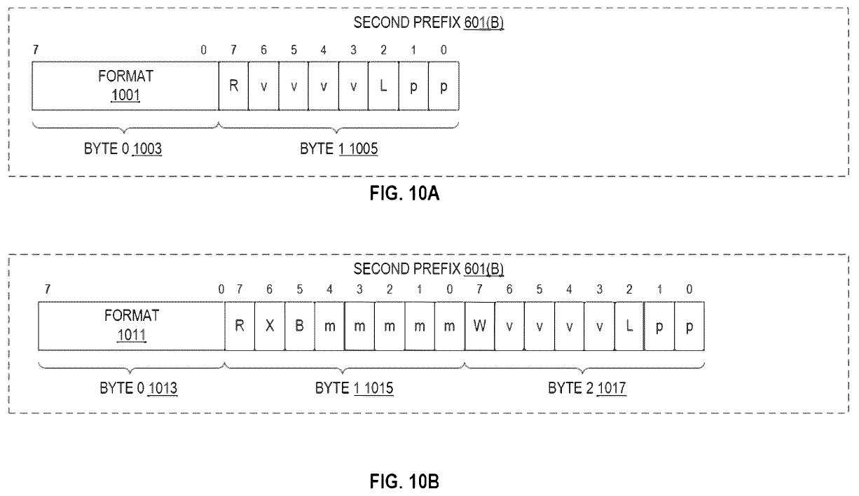

FIGS. 10(A)-(B) illustrate embodiments of a second prefix 601(B). In some embodiments, the second prefix 601(B) is an embodiment of a VEX prefix. The second prefix 601(B) encoding allows instructions to have more than two operands, and allows SIMD vector registers (e.g., vector/SIMD registers 510) to be longer than 64-bits (e.g., 128-bit and 256-bit). The use of the second prefix 601(B) provides for three-operand (or more) syntax. For example, previous two-operand instructions performed operations such as A=A+B, which overwrites a source operand. The use of the second prefix 601(B) enables operands to perform nondestructive operations such as A=B+C.

In some embodiments, the second prefix 601(B) comes in two forms-a two-byte form and a three-byte form. The two-byte second prefix 601(B) is used mainly for 128-bit, scalar, and some 256-bit instructions; while the three-byte second prefix 601(B) provides a compact replacement of the first prefix 601(A) and 3-byte opcode instructions.

FIG. 10(A) illustrates embodiments of a two-byte form of the second prefix 601(B). In one example, a format field 1001 (byte 0 1003) contains the value C5H. In one example, byte 1 1005 includes a “R” value in bit [7]. This value is the complement of the same value of the first prefix 601(A). Bit [2] is used to dictate the length (L) of the vector (where a value of 0 is a scalar or 128-bit vector and a value of 1 is a 256-bit vector). Bits [1:0] provide opcode extensionality equivalent to some legacy prefixes (e.g., 00=no prefix, 01=66H, 10=F3H, and 11=F2H). Bits [6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 746 to encode the instruction operand that references a memory address or encode either the destination register operand or a source register operand.

Instructions that use this prefix may use the Mod R/M reg field 744 to encode either the destination register operand or a source register operand, be treated as an opcode extension and not used to encode any instruction operand.

For instruction syntax that support four operands, vvvv, the Mod R/M R/M field 746 and the Mod R/M reg field 744 encode three of the four operands. Bits [7:4] of the immediate 609 are then used to encode the third source register operand.

FIG. 10(B) illustrates embodiments of a three-byte form of the second prefix 601(B). in one example, a format field 1011 (byte 0 1013) contains the value C4H. Byte 1 1015 includes in bits [7:5] “R,” “X,” and “B” which are the complements of the same values of the first prefix 601(A). Bits [4:0] of byte 1 1015 (shown as mmmmm) include content to encode, as need, one or more implied leading opcode bytes. For example, 00001 implies a 0FH leading opcode, 00010 implies a 0F38H leading opcode, 00011 implies a leading 0F3AH opcode, etc.

Bit [7] of byte 2 1017 is used similar to W of the first prefix 601(A) including helping to determine promotable operand sizes. Bit [2] is used to dictate the length (L) of the vector (where a value of 0 is a scalar or 128-bit vector and a value of 1 is a 256-bit vector). Bits [1:0] provide opcode extensionality equivalent to some legacy prefixes (e.g., 00=no prefix, 01=66H, 10=F3H, and 11=F2H). Bits [6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 746 to encode the instruction operand that references a memory address or encode either the destination register operand or a source register operand.

Instructions that use this prefix may use the Mod R/M reg field 744 to encode either the destination register operand or a source register operand, be treated as an opcode extension and not used to encode any instruction operand.

For instruction syntax that support four operands, vvvv, the Mod R/M R/M field 746, and the Mod R/M reg field 744 encode three of the four operands. Bits [7:4] of the immediate 609 are then used to encode the third source register operand.

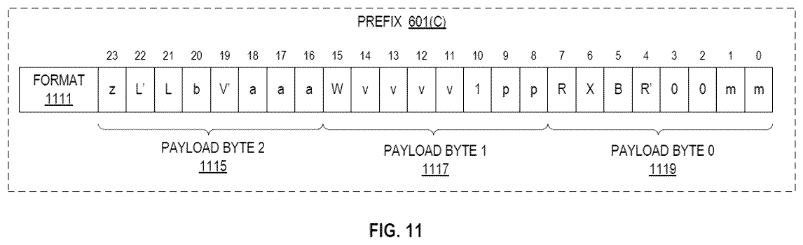

FIG. 11 illustrates embodiments of a third prefix 601(C). In some embodiments, the first prefix 601(A) is an embodiment of an EVEX prefix. The third prefix 601(C) is a four-byte prefix.

The third prefix 601(C) can encode 32 vector registers (e.g., 128-bit, 256-bit, and 512-bit registers) in 64-bit mode. In some embodiments, instructions that utilize a writemask/opmask (see discussion of registers in a previous figure, such as FIG. 5) or predication utilize this prefix. Opmask register allow for conditional processing or selection control. Opmask instructions, whose source/destination operands are opmask registers and treat the content of an opmask register as a single value, are encoded using the second prefix 601(B).

The third prefix 601(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 601(C) is a format field 1111 that has a value, in one example, of 62H. Subsequent bytes are referred to as payload bytes 1115-1119 and collectively form a 24-bit value of P[23:0] providing specific capability in the form of one or more fields (detailed herein).

In some embodiments, P[1:0] of payload byte 1119 are identical to the low two mmmmm bits. P[3:2] are reserved in some embodiments. Bit P[4] (R′) allows access to the high 16 vector register set when combined with P[7] and the ModR/M reg field 744. P[6] can also provide access to a high 16 vector register when SIB-type addressing is not needed. P[7:5] consist of an R, X, and B which are operand specifier modifier bits for vector register, general purpose register, memory addressing and allow access to the next set of 8 registers beyond the low 8 registers when combined with the ModR/M register field 744 and ModR/M R/M field 746. P[9:8] provide opcode extensionality equivalent to some legacy prefixes (e.g., 00=no prefix, 01=66H, 10=F3H, and 11=F2H). P[10] in some embodiments is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 601(A) and second prefix 611(B) and may serve as an opcode extension bit or operand size promotion.

P[18:16] specify the index of a register in the opmask (writemask) registers (e.g., writemask/predicate registers 515). In one embodiment of the invention, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While embodiments of the invention are described in which the opmask field's content selects one of a number of opmask registers that contains the opmask to be used (and thus the opmask field's content indirectly identifies that masking to be performed), alternative embodiments instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Exemplary embodiments of encoding of registers in instructions using the third prefix 601(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | ModR/M | GPR, | Destination or Source |
| | | | reg | Vector | |
| VVVV | V′ | vvvv | | GPR, | 2nd Source or |
| | | | | Vector | Destination |
| RM | X | B | ModR/M | GPR, | 1st Source or |
| | | | R/M | Vector | Destination |
| BASE | 0 | B | ModR/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | ModR/M reg | GPR, Vector | Destination or Source |
| VVVV | vvvv | GPR, Vector | 2^{nd} Source or Destination |
| RM | ModR/M R/M | GPR, Vector | 1^{st} Source or Destination |
| BASE | ModR/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | ModR/M Reg | k0-k7 | Source |
| VVVV | vvvv | k0-k7 | 2^{nd} Source |
| RM | ModR/M R/M | k0-7 | 1^{st} Source |
| {k1] | aaa | k0¹-k7 | Opmask |

Program code may be applied to input instructions to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

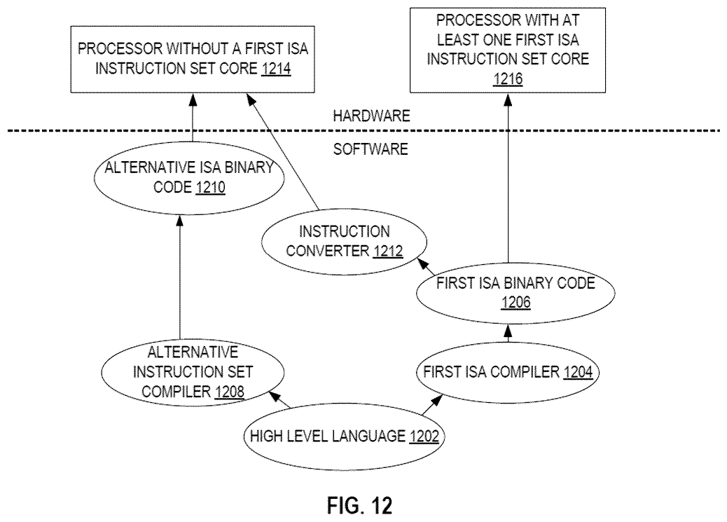

FIG. 12 illustrates a block diagram contrasting the use of a software instruction converter to convert binary instructions in a source instruction set to binary instructions in a target instruction set according to certain implementations. In the illustrated embodiment, the instruction converter is a software instruction converter, although alternatively the instruction converter may be implemented in software, firmware, hardware, or various combinations thereof. FIG. 12 shows a program in a high level language 1202 may be compiled using a first ISA compiler 1204 to generate first ISA binary code 1206 that may be natively executed by a processor with at least one first instruction set core 1216. The processor with at least one first ISA instruction set core 1216 represents any processor that can perform substantially the same functions as an Intel® processor with at least one first ISA instruction set core by compatibly executing or otherwise processing (1) a substantial portion of the instruction set of the first ISA instruction set core or (2) object code versions of applications or other software targeted to run on an Intel processor with at least one first ISA instruction set core, in order to achieve substantially the same result as a processor with at least one first ISA instruction set core. The first ISA compiler 1204 represents a compiler that is operable to generate first ISA binary code 1206 (e.g., object code) that can, with or without additional linkage processing, be executed on the processor with at least one first ISA instruction set core 1216.

Similarly, FIG. 12 shows the program in the high level language 1202 may be compiled using an alternative instruction set compiler 1208 to generate alternative instruction set binary code 1210 that may be natively executed by a processor without a first ISA instruction set core 1214. The instruction converter 1212 is used to convert the first ISA binary code 1206 into code that may be natively executed by the processor without a first ISA instruction set core 1214. This converted code is not likely to be the same as the alternative instruction set binary code 1210 because an instruction converter capable of this is difficult to make; however, the converted code will accomplish the general operation and be made up of instructions from the alternative instruction set. Thus, the instruction converter 1212 represents software, firmware, hardware, or a combination thereof that, through emulation, simulation or any other process, allows a processor or other electronic device that does not have a first ISA instruction set processor or core to execute the first ISA binary code 1206.

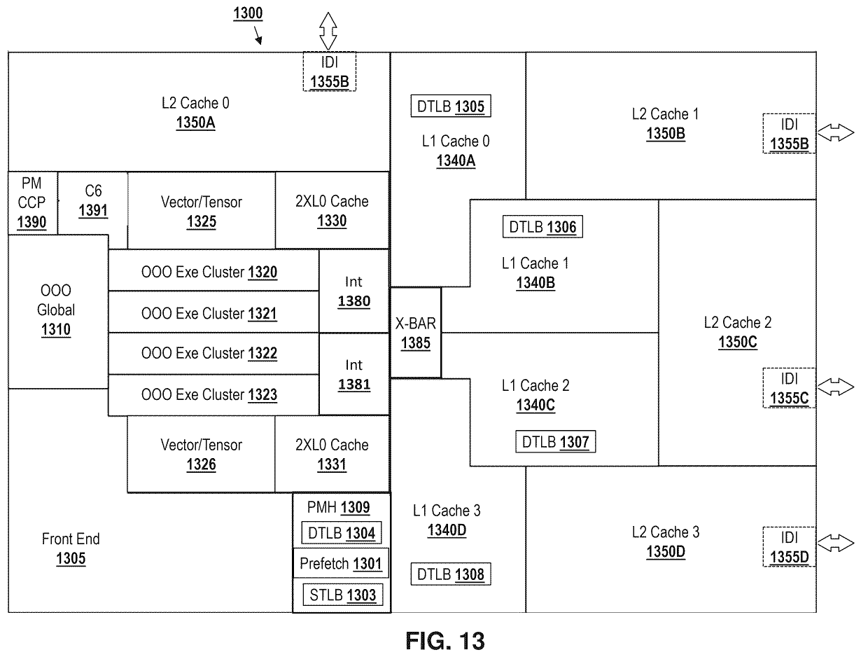

FIG. 13 illustrates an example processor 1300 (or processor tile integrated on the processor package with other processor tiles) on which the embodiments described herein may be implemented. Four out-of-order (OOO) processing clusters 1320-1323 with out-of-order instruction processing and execution circuitry are coupled to a corresponding plurality of L1 cache slices 1340A-D via a crossbar fabric 1385 via one or more respective interfaces 1380-1381. Front end circuitry 1305 performs instruction fetching and scheduling operations to dispatch the instructions to the OOO clusters 1320-1323 and/or global OOO circuitry 1310 which maintains global ordering in operations performed by the OOO clusters 1320-1323 while executing instructions. In certain examples, the OOO clusters 1320-1323 or the front end circuitry 1305 divide an instruction stream into groups of contiguous instructions or “strands,” several of which may be executed simultaneously on separate OOO clusters 1320-1323.

In the illustrated example, the processor includes a memory and cache subsystem comprising the L1 cache slices 1340A-D, as well as a set of L2 cache slices 1350A-D, which include respective in-die interconnects (IDIs) 1355A-D to couple to a next level cache (e.g., an L3 cache or LLC) and/or to a memory controller coupled to a system memory, such as a DDR DRAM memory (not shown).

Some processor components use virtual memory addresses which are translated to physical memory addresses via data-side translation lookaside buffers (DTLBs) 1304-1308 and one or more second level TLBs (STLB) 1303. A page miss handler (PMH) 1309 performs page walk operations in response to TLB misses (i.e., when a required virtual-to-physical address translation is not present in one of the TLBs). In some implementations, a primary DTLB 1304 is one of five DTLBs 1304-1308 distributed throughout the processor. In particular, each L1 data cache (D$) slice 1340A-D includes a respective DTLB 1305-1308, which are synchronized with the primary DTLB 1304. For example, the PMH 1309 or other logic may perform synchronization operations in response to TLB updates and invalidations to ensure that all five DTLB 1304-1308 are coherent with each other (i.e., continually updated to store the same set of entries).

Prefetch circuitry 1301 may observe patterns in STLB 1303 hits, learn whether the pattern is sequential or irregular, and manage a pattern table to identify the irregular patterns. When the prefetch circuitry 1301 decides to prefetch a TLB entry from the STLB 1303 to the DTLB 1304, it attempts to read the entry out of the STLB, but if it is not found in the STLB 1303, then the prefetch is dropped (i.e., the prefetch circuitry 1301 does not cause additional page walk operations).

The OOO execution clusters 1320 and/or front end 1305 may offload certain types of instructions/operations to vector/tensor execution circuits 1325-1326, which include parallel execution circuitry for performing vector or tensor operations on matrices, as described herein. Vector operations may be performed, for example, to process sets of data elements packed into SIMD/vector registers. Tensor operations may be performed on multi-dimensional data elements (e.g., 2D matrices) packed into tile registers (e.g., groups of vector registers) to perform matrix operations (e.g., such as matrix multiplications described herein).

The other illustrated processor blocks include a power management circuit 1390 for performing power control operations such as voltage and PLL (i.e., frequency) regulation. A C6 circuit 1391 retains the execution state associated with one or more threads, strands, or instructions when one or more of the vector execution circuits 1325-1326 or OOO clusters 1320-1323 enter into a C6 low power state

In some embodiments, the vector/tensor execution circuits 1325-1326 are vector execution circuits which primarily execute SIMD/vector operations and tensor acceleration circuitry external to the processor performs 2D, 3D, 4D, etc, tensor operations, such as matrix multiplications. For example, the processor 1300 may be integrated on a package with a plurality of other tiles, some of which may include tensor operations circuitry.

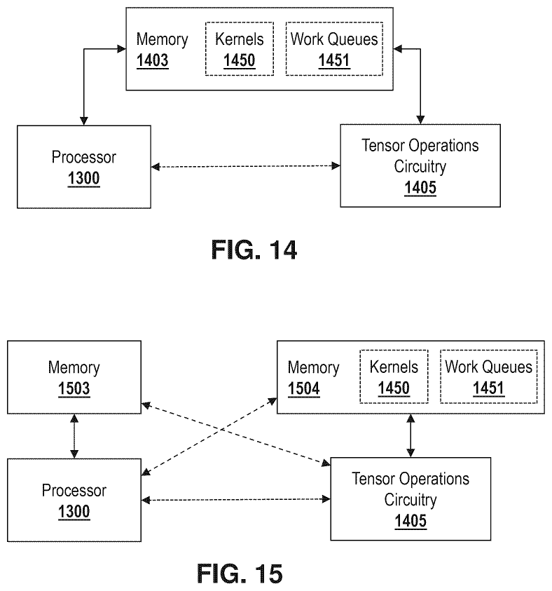

FIG. 14 illustrates one example in which a memory 1403 is shared between the processor 1300 and tensor operations circuitry 1405. In this configuration, the processor 1300 may set up work queues 1451 (e.g., in response to executing program code) for submitting work to the tensor operations circuitry 1405. Each work queue 1451 may include a plurality of entries submitted by the processor 1300, where each entry identifies a tensor kernel 1450 (or other program code structure) to be executed. The tensor operations circuitry 1405 reads each entry from a given work queue 1451 to identify a corresponding kernel 1450, which it responsively executes.

FIG. 15 illustrates another implementation in which the memory subsystem includes a system memory 1503 accessible to the processor 1300 and a device memory 1504 associated with the tensor operations circuitry 1405 (e.g., on the same chip as the tensor operations circuitry 1405). As in FIG. 14, the processor is provided access to the device memory 1504 to set up work queues 1451 identifying kernels 1450 to be executed, as described above. Alternatively or additionally, the tensor operations circuitry 1405 may be provided with access to the system memory 1503 (or a portion thereof) in addition to the device memory 1504 and may share a portion of a virtual address space with the processor 1300 (e.g., in a shared virtual memory (SVM) implementation). In this implementation, the device memory 1504 stores program code and data which is accessed most frequently by the tensor operations circuitry 1405 (i.e., to improve performance).

### Apparatus and Method for Matrix Processing on a Clustered Processor Core

As mentioned, certain types of program code, such as matrix multiplication kernels, perform operations using matrix-oriented instructions (e.g., FMA instruction, VNNI instructions, VPMM instructions). By way of example, and not limitation, General Matrix Multiply (GeMM) kernels may be executed by the processor 1300 to multiply a first source matrix and a second source matrix to generate a result matrix.

Embodiments of the invention include a matrix operation detector that monitors the instruction stream and identifies when a matrix operation kernel is currently being run on a processor core (e.g., by one or more of the OOO execution clusters 1320-1323). A two-level dynamic reservation station (RS)-scheduling protocol is implemented that favors younger microoperations when in the matrix operation mode and favors older microoperations when in a baseline mode of operation (i.e., a non-matrix operation mode).

In addition, while in matrix operation mode, some embodiments balance between extracting long-distance instruction level parallelism (ILP) while ensuring forward progress of older instructions so that other processing resources are not blocked/starved. These embodiments may also include adaptive cluster steering that adjusts the cluster steering frequency based on the matrix operation kernel type (e.g., based on variables such as the instruction mix, the compute-to-load ratio, etc).

In one embodiment, the matrix operation mode detector determines whether the workload is a matrix processing kernel (or a kernel with similar sets of operations) and automatically triggers a matrix operation scheduling mode. The matrix operation mode detector, for example, may evaluate the retired instruction mix for a fixed size interval (e.g., 20 K retired instructions). Within the instruction interval, it will calculate the density of instructions associated with matrix operation kernels (sometimes referred to as “matmul-density”). In one particular implementation, the instructions include fused multiply-accumulate (FMA) instructions, vector neural network instructions (VNNI), vector packed matrix multiplication (VPMM) instructions, and multiply-add/multiply-accumulate (MAC) instructions. In addition, some implementations determine the load instruction density based on the number of load instructions within the same time interval (“load-density”). If one or both of matmul-density and load-density exceed corresponding threshold(s), then the matrix operation mode detector will predict matrix operation mode (e.g., for the next interval of instructions).

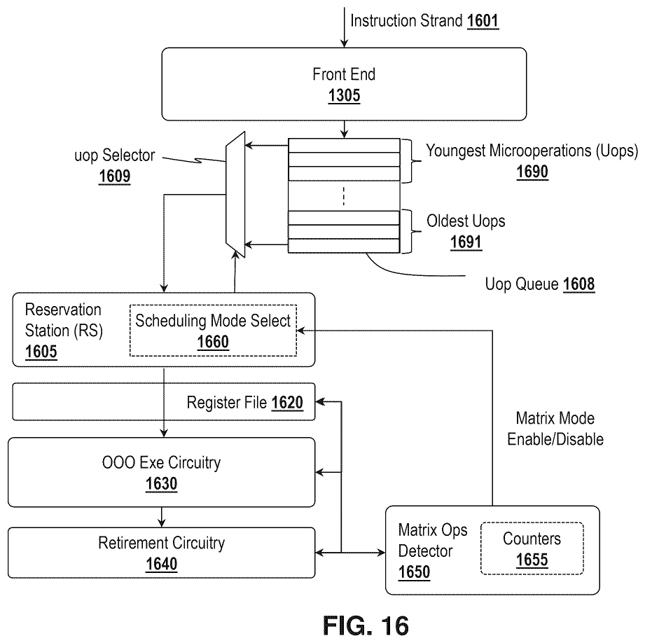

FIG. 16 illustrates an example in which instructions of a particular instruction strand 1601 are fetched and decoded into microoperations (uops) by the front end 1305. The uops are stored in a uop queue 1608, which may be a queue dedicated to the particular instruction strand 1601 or a queue for storing uops of multiple instruction strands. A reservation station (RS) 1605 selects uops from the uop queue 1608 to be dispatched for execution by the OOO execution circuitry 1630 (e.g., within one of the OOO execution clusters 1320-1323) in accordance with a current scheduling mode. The OOO execution circuitry 1630 executes the uops, accessing operands from registers of a register file 1620 as needed. In the embodiments described herein, the registers may include packed data registers and/or matrix registers (sometimes referred to as “tile” registers). Retirement circuitry 1640 retires the uops and writes back results to the register file 1620 and/or the memory subsystem (assuming no exceptions occurred during execution).

In some embodiments of the invention, a matrix operation detector 1650 tracks the relative frequency of matrix processing instructions/uops using a set of one or more counters 1655. By way of example, and not limitation, in response to detecting a retirement of an FMA uop, VNNI uop, a VPMM uop, or a MAC uop, a corresponding counter of the one or more counters 1655 may be incremented. In addition, a total uops retired counter may be incremented in response to the retirement of any uop, regardless of type. The counting may continue within a fixed size interval, such as a specified number of uops (e.g., 20 K total). At the end of each fixed interval, the matrix operation detector 1650 can determine the matrix instruction density (e.g., matmul-density) based on the number of retired matrix processing uops relative to the total number of retired uops (e.g., 1 matrix processing uop per every 4 uops). The matrix operation detector 1650 can determine the load-density in a similar manner—i.e., counting the number of load uops within the given fixed interval. In some embodiments, the load uops which are counted are those which indicate a physical vector destination register within the register file 1620.

In some implementations, when the density of matrix processing uops, load uops, or a combination thereof reaches a first one or more thresholds, the matrix operation detector 1650 signals to scheduling mode selection logic 1660 of the reservation station 1605 to enter a matrix operation scheduling mode for the next interval. Separate thresholds may be defined for the density of the matrix processing uops and load uops. If both thresholds are reached or surpassed, the matrix operation detector 1650 may signal to the RS 1605 to enter into the matrix operation scheduling mode. Alternatively, a single threshold may be defined for the combined density of the matrix processing and load uops.

Similarly, when the density of matrix processing uops, load uops, or a combination thereof drops below a second one or more thresholds, the matrix operation detector 1650 may signal to the scheduling mode selection logic 1660 to exit the matrix operation scheduling mode (e.g., and revert to baseline RS scheduling). The second one or more thresholds may be the same as the first one or more thresholds or may be different from first one or more thresholds (e.g., slightly lower than the first one or more thresholds). Separate thresholds may also be defined for the matrix processing uops and load uops. If the uop density for either uop type drops below its respective threshold, the matrix operation detector 1650 may signal the scheduling mode selection logic 1660 to exit from the matrix operation scheduling mode and/or to enter into the RS scheduling mode.

As mentioned, when in the matrix operation scheduling mode, the reservation station 1605 may prioritize or otherwise favor the youngest microoperations 1690 (i.e., the uops most recently added to the uop queue 1608). In contrast, when in the baseline or non-matrix operation scheduling mode, the reservation station 1605 may prioritize or otherwise favor the oldest uops 1691 in the uop queue 1691.

While the above discussion focuses on uops of a single instruction strand 1601, the embodiments of the invention operate to schedule uops from multiple instruction strands based on matmul-density and/or load-density. In these embodiments, when the reservation station 1605 is in the baseline or non-matrix operation scheduling mode, older uops are prioritized ahead of younger uops. When the RS 1605 is switched to the matrix operation scheduling mode, the youngest uops in the oldest strand in each cluster are prioritized ahead of all other uops, followed by the oldest uops in all younger strands.

In one particular embodiment, to determine the matmul-density, each uop associated with matrix operation kernels (e.g., based on the determined uop type) is counted once by the matrix operation detector 1650. In addition, the minimum of mul (multiply) and add uops, min (#VecMulUops, #VecAddUops) may be counted, regardless of whether they are packed or scalar operations. For load-density, the matrix operation detector counts all load uops indicating a physical vector destination register in the register file 1620, regardless of the load width.

The matrix operation detector then determines whether to cause the reservation station 1605 to enter into the matrix operation mode if the matmul-density is above a first defined threshold (thresholdmatmul) and load-density is above a second defined threshold (thresholdload), as indicated below:

```
totalMatmulUops = #FmaUops + #VnniUops + #VpmmUops +
min(#VecMulUops, #VecAddUops)
totalLoadUops = #VecScalarLoadUops + #VecLoadUops
if (totalMatmulUops > thresholdmatmul) and (totalLoadUops >
thresholdload)
  predict GEMM_MODE
else
  predict REGULAR_MODE
```

Thus, in accordance with some embodiments, the matrix operation detector 1650 will signal to the scheduling mode selection logic 1660 upon detecting densities of matrix processing uops and load uops both exceeding their respective thresholds. The reservation station 1605 will then enter matrix operation mode during the next internal (e.g., the next interval of 20 K or other number of instructions). Once in matrix operation mode, the reservation station 1605 will change its uop scheduling policy on all relevant execution ports (e.g., on all vector/matrix ALU ports) from oldest-first scheduling to youngest-first for the oldest strand in each cluster, followed by oldest-first for all other uops. A uop selector 1609, responsive to the RS 1605, will select the uops from the uop queue 1608 in accordance with the selected uop scheduling policy. In these embodiments, the uop selector 1609 may include a set of uop picker circuits configured based on the selected mode. For example, an oldest-first picker circuit may operate in accordance with the baseline scheduling policy (i.e., picking the oldest uop for execution if resources are available). When in matrix operation mode, a youngest-first picker circuit is given priority over the oldest-first picker circuit to select the youngest uops in the oldest strand. Once these uops have been scheduled, the oldest-first picker circuit may then pick uops in accordance with the oldest-first policy.

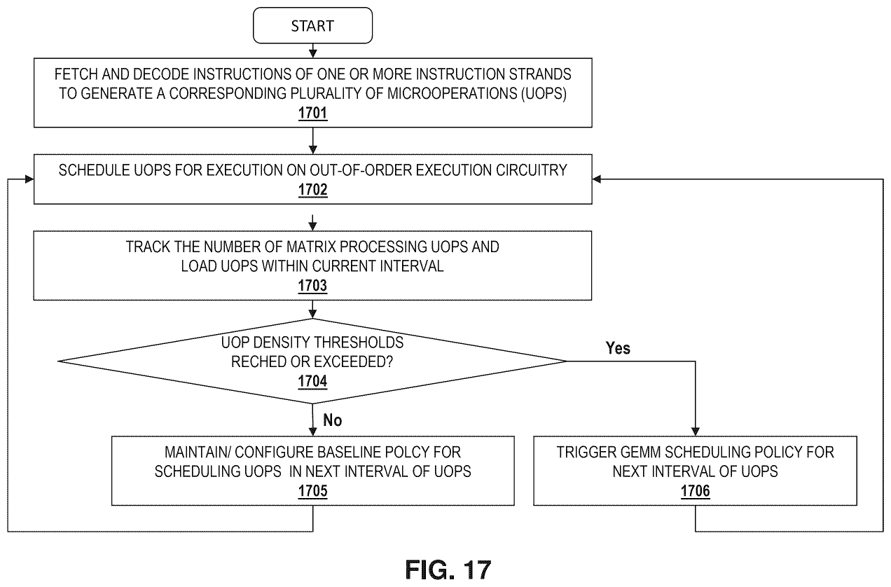

A method in accordance with some embodiments of the invention is illustrated in FIG. 17. The method may be implemented within the context of the various architectures described herein, but is not limited to any particular processor or system architecture.

At 1701, instructions of one or more instruction strands are fetched and decoded to generate a corresponding plurality of microoperations (uops). As mentioned, an instruction strand comprises a block or group of contiguous instructions. At 1702, the uops are scheduled for execution on out-of-order execution circuitry.

At 1703, the number of retired matrix processing uops and load uops are counted along with the total number of retired uops. As mentioned, matrix processing uops may be defined as FMA uops, VNNI uops, VPMM uops, and the minimum of vector multiply and add uops. Load uops may be defined as those load uops with a physical vector register indicated as a destination operand.

At 1704, a determination is made as to whether uop density thresholds have been reached or exceeded within the current interval. As mentioned, the uop densities may be defined as the ratios of retired matrix processing uops and load uops relative to other retired uops. Separate thresholds may be defined for load uop density and matrix processing uop density. If both thresholds are reached or exceeded, then at 1706, a matrix operation scheduling policy is triggered for the next interval of uops (e.g., 20 K or other defined number of uops). As mentioned, the matrix operation scheduling policy may comprise performing youngest-first scheduling for uops of the oldest strand and performing oldest-first scheduling for the remaining uops.

If the thresholds are not exceeded at 1704, then at 1705, a baseline policy is maintained/configured for the next interval of uops. For example, the baseline policy may comprise an oldest-first policy (i.e., prioritizing the oldest uops for execution).

### Examples of a Vector Packed Matrix Multiplication (VPMM) Instruction

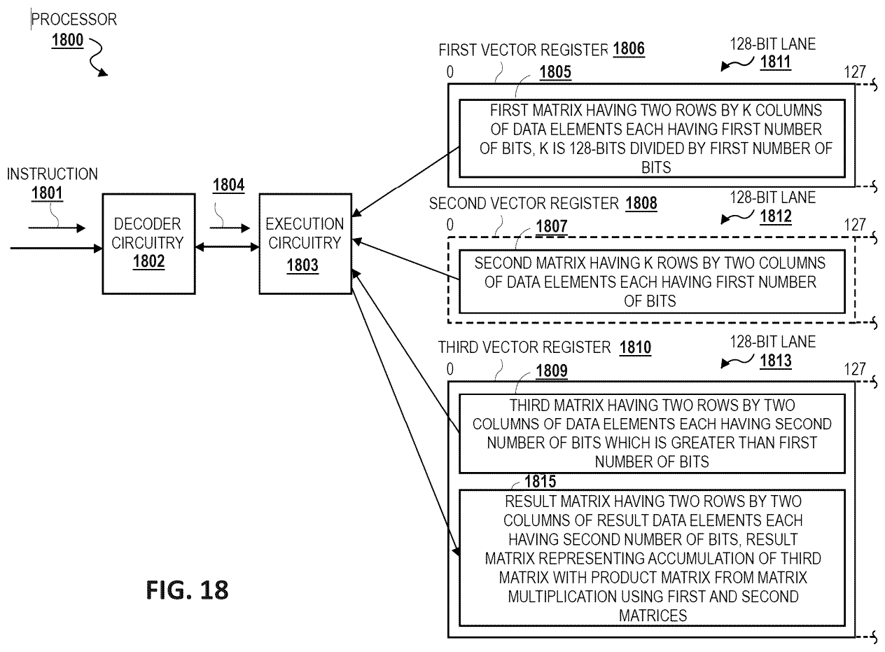

A vector packed matrix multiplication uop is a particular type of matrix processing uop described with respect to the above embodiments. Examples of a VPMM instruction and corresponding uop(s) are described below with respect to FIGS. 18-21.

FIG. 18 is a block diagram of an embodiment of a processor 1800 that is operative to perform an embodiment of an instruction 1801 (e.g., a vector packed matrix multiplication and accumulation instruction). In some embodiments, the processor may be a general-purpose processor (e.g., a general-purpose microprocessor or central processing unit (CPU) of the type used in desktops, laptops, servers, smartphones, and other computer systems). Alternatively, the processor may be a special-purpose processor. Examples of suitable special-purpose processors include, but are not limited to, machine-learning processors, artificial intelligence processors, co-processors, graphics processors, network processors, communications processors, cryptographic processors, and digital signal processors (DSPs). The processor may have any of various complex instruction set computing (CISC) architectures, reduced instruction set computing (RISC) architectures, very long instruction word (VLIW) architectures, hybrid architectures, other types of architectures, or have a combination of different architectures (e.g., different cores may have different architectures). In some embodiments, the processor may include (e.g., be disposed on) at least one integrated circuit or semiconductor die. In some embodiments, the processor may include at least some hardware (e.g., transistors, capacitors, circuitry, non-volatile memory storing circuit-level instructions/control signals).

In various different embodiments, the first number of bits of the data elements of the first and second matrices may be 2-bits, 4-bits, 8-bits, 16-bits, or 32-bits. For 2-bit data elements, K may be thirty-two. For 4-bit data elements, K may be sixteen. For 8-bit data elements, K may be eight. For 16-bit data elements, K may be four. For 32-bit data elements, K may be two. Examples of suitable types of 2-bit and 4-bit data elements for the first and second matrixes include, but are not limited to, 2-bit and 4-bit signed and unsigned integers. Examples of suitable types of 8-bit data elements for the first and second matrixes include, but are not limited to, 8-bit signed integers (S8), 8-bit unsigned integers (U8), and 8-bit floating-point data elements (FP8). Examples of suitable types of 8-bit floating-point data elements for the first and second matrixes include, but are not limited to, bfloat8 (BF8) having five exponent bits and two explicit mantissa/significand bits and hfloat8 (HF8) having four exponent bits and three explicit mantissa/significand bits. In various embodiments, the first and second matrices may both have S8 data elements, the first and second matrices may both have U8 data elements, the first matrix may have S8 data elements and the second matrix may have U8 data elements, or the first matrix may have U8 data elements and the second matrix may have S8 data elements. In various other embodiments, the first and second matrices may both have BF8 data elements, the first and second matrices may both have HF8 data elements, the first matrix may have BF8 data elements and the second matrix may have HF8 data elements, or the first matrix may have HF8 data elements and the second matrix may have BF8 data elements. Examples of suitable types of 16-bit data elements for the first and second matrixes include, but are not limited to, 16-bit signed integers (S16), 16-bit unsigned integers (U16), half precision floating-point data elements (float16 or F16), and bfloat16 (BF16 floating-point data elements. In various embodiments, the first and second matrices may both have F16 data elements, or the first and second matrices may both have BF16 data elements. Examples of suitable types of 32-bit data elements for the first and second matrixes include, but are not limited to, 32-bit signed integers (S32), 32-bit unsigned integers (U32), single-precision floating-point data elements (float32 or F32), and TensorFloat-32 floating-point data elements (TF32) having eight exponent bits and ten explicit mantissa/significand bits. In some embodiments, the first and second matrices may both have TF32 data elements.

Conventionally, vector registers have been used to store vectors but typically not matrices. Vectors are also sometimes referred to in the art as packed data and SIMD data. Vectors represent one-dimensional arrays or data structures. In contrast, in some embodiments, at least one vector register may be used to store a matrix. The matrix may represent are two-dimensional arrangement of data elements (e.g., numbers or values) into rows and columns. However, rather than the matrix being stored in a tile, two-dimensional set of registers, or other two-dimensional storage structure, the matrix may be stored in a single vector register (e.g., in a single vector and/or one-dimensional layout). Such a matrix may also be referred to herein as a vector packed matrix because the matrix is packed into a vector or one-dimensional layout.

The vector registers 1806, 1808, 1810 may represent architecturally-visible or architectural registers that are visible to software and/or a programmer and/or are the registers indicated by instructions of the instruction set of the processor to identify operands. These architectural registers are contrasted to other non-architectural registers in a microarchitecture (e.g., temporary registers, reorder buffers, retirement registers, etc.). These vector registers may be implemented in different ways in different microarchitectures and are not limited to any particular design. Examples of suitable types of vector registers include, but are not limited to, dedicated physical registers, dynamically allocated physical registers using register renaming, and combinations thereof.

Referring again to FIG. 18, the processor includes decoder circuitry 1802 (e.g., an instruction decoder). The decoder circuitry may be coupled to receive the instruction. The decoder circuitry may be operative to decode the instruction into one or more lower-level control signals, operations, or decoded instructions 1804 (e.g., one or more micro-instructions, micro-operations, micro-code entry points, etc.). In some embodiments, the decoder circuitry may include at least one input structure (e.g., a port, interconnect, or interface) coupled to receive the instruction, an instruction recognition and decode logic coupled therewith to recognize and decode the instruction into one or more lower-level control signals, operations, or decoded instructions, and at least one output structure (e.g., a port, interconnect, or interface) coupled therewith to output the one or more lower-level control signals, operations, or decoded instructions. The decoder circuitry and/or its instruction recognition and decode logic may be implemented using various instruction decode mechanisms including, but not limited to, microcode read only memories (ROMs), look-up tables, hardware implementations, programmable logic arrays (PLAs), other mechanisms suitable to implement instruction decoder circuitry, and combinations thereof. In some embodiments, the decoder circuitry may include at least some hardware (e.g., transistors, integrated circuitry, on-die read-only memory or other non-volatile memory storing microcode or other hardware-level instructions, or any combination thereof). In some embodiments, the decoder circuitry may be included on a die, integrated circuit, or semiconductor substrate.

Execution circuitry 1803 (e.g., an execution unit) is coupled with the decoder circuitry 1802 (e.g., to receive the one or more lower-level control signals, operations, or decoded instructions 1804). The execution circuitry is also coupled to receive the first, second, and third matrices 1805, 1807, 1809 (e.g., coupled with the first, second, and third vector registers 1806, 1808, 1810). In some embodiments, the execution circuitry may be on a die or integrated circuit along with the decoder circuitry. The execution circuitry may be operative to perform operations corresponding to and/or as specified by and/or as controlled by the instruction 1801. For example, the one or more lower-level control signals, operations, or decoded instructions may be executed by the execution circuitry to control the execution circuitry to perform operations corresponding to the instruction (e.g., operations that are at least partially specified by the opcode of the instruction).

In some embodiments, the operations may include generating a result matrix 1815 having two rows by two columns (e.g., M=2, N=2) of result data elements each having the second number of bits. In some embodiments, the second number of bits is 32 bits. In some embodiments, the result matrix may represent an accumulation of the third matrix 1809 (e.g., an accumulation matrix) with a product matrix (e.g., having two rows by two columns) generated from a matrix multiplication using and/or involving and/or based on the first and second matrices 1805, 1807. By way of example, the product matrix having M rows by N columns may be generated by matrix multiplication involving the first matrix having M rows by K columns and the second matrix having K rows by N columns, where M and N are each two. In some embodiments, the product matrix may be generated from a matrix multiplication using the first and second matrices in which the data elements of the first and second matrices are converted from the first number of bits to a greater number of bits (e.g., converted from 8-bits or 16-bits to 32-bits) prior to the matrix multiplication. In some embodiments, the product matrix may be generated from a matrix multiplication using the first and second matrices in which floating-point rounding may optionally be performed as needed during the matrix multiplication and/or accumulation. In various embodiments, rounding may be performed as needed after each multiplication used to generate each result element, rounding may be performed as needed after each accumulate operation used to generate each result element, rounding may be performed as needed after each multiplication used to generate each result element and also as needed after each accumulate operation used to generate each result element, as needed once after all operations to generate a result element. In some embodiments, the operations may include storing the result matrix in the 128-bit lane of the third vector register that was initially used to store the third matrix. That is, the third vector register may be a source/destination vector register that is initially used as a source of the third vector and implicitly subsequently reused as a destination where the result matrix is to be stored.

In some embodiments, the execution circuitry, to generate and store the result matrix, may perform operations including, for each column n of the two columns of the second matrix, and for each row m of the two rows of the first matrix: (1) converting K data elements from the row m of the first matrix to K corresponding converted data elements each having more bits than the first number of bits, and convert K data elements from the column n of the second matrix to K corresponding converted data elements each having more bits than the first number of bits; (2) generating K products, including multiplying the K converted data elements corresponding to the row m and the K converted data elements corresponding to the column n, where generating the K products optionally may include performing rounding as needed; (3) generating a result data element having the second number of bits, including accumulating the K products with a data element from a corresponding row m of the two rows, and a corresponding column n of the two columns, of the third matrix, where generating a result data element optionally may include performing rounding as needed; and (4) storing the result data element in the 128-bit lane of the third vector register at a position corresponding to the row m and the column n of the third matrix. The accumulating of the K products with the data element from the third matrix as mentioned immediately above for item (3) may be performed in various different ways including accumulating the K products in various different orders with the data element from the third matrix. In some embodiments, the execution circuitry, to generate and store the result matrix, may perform any of the operations of the example embodiments of the instructions shown and described further below.

In some embodiments, the first vector register 1806 may optionally have a second 128-bit lane to store a fourth matrix having two rows by K columns of data elements each having the first number of bits, the second vector register 1808 may optionally have a second 128-bit lane to store a fifth matrix having K rows by two columns of data elements each having the first number of bits, and the third vector register 1810 may optionally have a second 128-bit lane to store a sixth matrix having two rows by two columns of data elements each having the second number of bits. In such embodiments, the execution circuitry, to perform the operations corresponding to the instruction, may further generate a second result matrix having two rows by two columns (e.g., M=2, N=2) of result data elements each having the second number of bits. In some embodiments, the second result matrix may represent an accumulation of the sixth matrix (e.g., a second accumulation matrix) with a product matrix (e.g., having two rows by two columns) generated from a matrix multiplication using the fourth and fifth matrices. The second result matrix may be stored in the second 128-bit lane of the third vector register. In other embodiments, there may be additional 128-bit lanes or portions. A separate 2×2×K matrix multiply-accumulation operation may be performed for each of these 128-bit lanes or portions of the vector registers.

In some embodiments, the processor may have a register (e.g., a MXCSR or other floating-point control register) to control floating-point operations. In some embodiments, the register may have one or more fields (e.g., rounding mode field) to specify one of a plurality of supported rounding modes to be used for floating-point operations. In some embodiments, the execution circuitry, to perform the operations corresponding to the instruction, when at least some data elements of the matrices are floating-point data elements, may perform rounding according to only a single rounding mode (e.g., a round to nearest even rounding mode) regardless of and/or irrespective of and/or without checking the one or more fields (e.g., the rounding mode field) in the register. In some such embodiments, the rounding may be performed according to the single rounding mode in a mathematically precise way rather than through a simplification which leads to mathematically imprecise results. In some embodiments, the register may have one or more fields (e.g., a Denormals-Are-Zero (DAZ) bit or field) to specify whether denormal values in the inputs to floating-point instructions/operations (e.g., the source matrices) are to be set or made to be or treated as zero. In some such embodiments, the execution circuitry, to perform the operations corresponding to the instruction, when at least some data elements of the matrices are floating-point data elements, may set or make denormals in the inputs to floating-point operations as zero or treat denormals in the inputs to floating-point operations as zero regardless of and/or irrespective of and/or without checking whether the one or more fields (e.g., the DAZ bit or field) in the register specify whether denormal results of floating-point operations are to be forced to zero. In some embodiments, the register may have one or more fields (e.g., a Flush-To-Zero (FTZ) bit or field) to specify to specify to specify whether denormal results of floating-point operations are to be set, forced, or made to be zero. In some such embodiments, the execution circuitry, to perform the operations corresponding to the instruction, when at least some data elements of the matrices are floating-point data elements, may to set, force, or make denormal results of floating-point operations are to be to be zero regardless of and/or irrespective of and/or without checking whether the one or more fields (e.g., the FTZ bit or field) in the register specify whether denormal results of floating-point operations are to be set, forced, or made to be zero. In some embodiments, the execution circuitry, when at least some data elements of the matrices are floating-point data elements, may complete performance of the operations corresponding to the instruction without accessing (e.g., without reading from and without writing to) the register (e.g., the MXCSR or other floating-point control register).

The execution circuitry and/or the processor may include specific or particular logic (e.g., transistors, integrated circuitry, or other hardware potentially combined with firmware (e.g., instructions stored in non-volatile memory) and/or software) that is operative to perform the instruction and/or store the result matrix in response to and/or due to the instruction (e.g., in response to the one or more lower-level control signals, operations, or decoded instructions that have been decoded from the instruction). In some embodiments, the execution circuitry may include multiplication circuitry (e.g., matrix multiplication circuitry), addition circuitry (e.g., matrix addition circuitry), floating-point rounding circuitry, and circuitry to perform other operations described herein. In some embodiments, the execution circuitry may include one or more input structures (e.g., a port, interconnect, or interface) coupled to receive the first, second, and third matrices, circuitry or logic coupled therewith to receive and process these matrices to generate the result matrix, and one or more output structures (e.g., a port, interconnect, or interface) coupled therewith to output the result matrix (e.g., store it in a vector register).

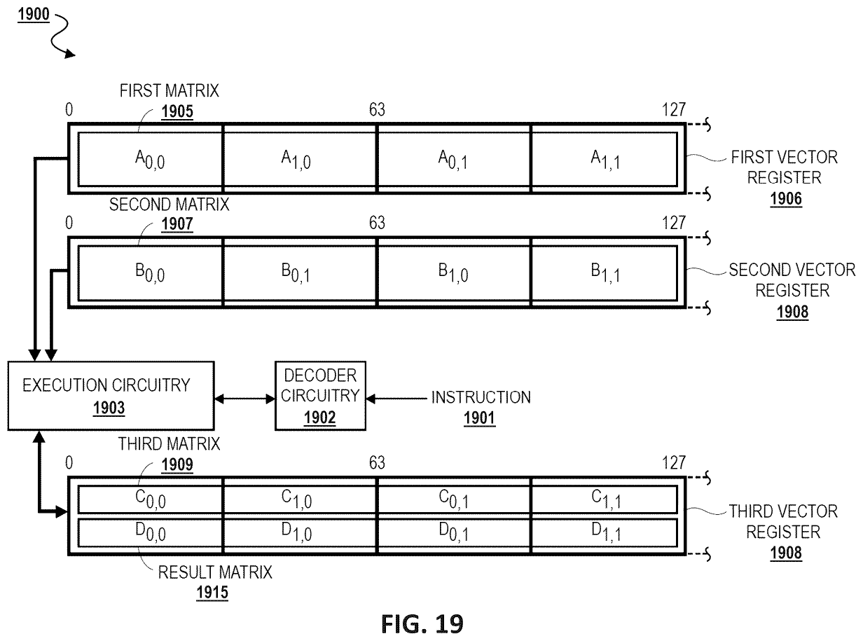

FIG. 19 is a block diagram of an embodiment of a processor 1900 to perform a vector packed matrix multiplication and accumulation instruction 1901 to perform vector packed matrix multiplication and accumulation operations using a first matrix 1905 and a second matrix 1907 both having 32-bit data elements. The processor includes a decoder circuitry 1902 to decode the vector packed matrix multiplication and accumulation instruction. The decoder circuitry may be similar to, or the same as, the decoder circuitry 1802 described for FIG. 18. The instruction may specify or otherwise indicate a first vector register 1906 having a 128-bit lane storing the first matrix 1905, a second vector register 1908 having a 128-bit lane storing the second matrix 1907, and a third vector register 1910 having a 128-bit lane storing a third matrix 1909.

For these 32-bit data elements, the first and second matrices have common dimension K=2 (e.g., K=2=64/32). The first matrix has four 32-bit data elements, arranged in two rows by two columns, labeled A_{0,0} in bits [31:0], A_{1,0} in bits [63:32], A_{0,1} in bits [95:64], and A_{1,1} in bits [127:96], where the A elements are indexed as A_{k,m}. The second matrix has four 32-bit data elements, arranged in two rows by two columns, labeled B_{0,0} in bits [31:0], B_{0,1} in bits [63:32], B_{1,0} in bits [95:64], and B_{1,1} in bits [127:96], where the B elements are indexed as B_{n,k}. The third matrix has four 32-bit data elements, arranged in two rows by two columns, labeled C_{0,0} in bits [31:0], C_{1,0} in bits [63:32], C_{0,1} in bits [95:64], and C_{1,1} in bits [127:96], where the C elements are indexed as C_{n,m}. This arrangement of the 32-bit data elements within the matrices may tend to be more efficient than certain other arrangements (e.g., in terms of managing the smaller matrices as part of an overall algorithm of multiplying and accumulating larger matrices), although other arrangements may optionally be used, if desired.

Execution circuitry 1903 is coupled with the decoder circuitry 1902. The execution circuitry may perform vector packed matrix multiplication and accumulation operations corresponding to the instruction. These operations may include generating a result matrix 1915. The result matrix may have four 32-bit data elements, arranged in two rows by two columns, labeled D_{0,0} in bits [31:0], D_{1,0} in bits [63:32], D_{0,1} in bits [95:64], and D_{1,1} in bits [127:96], where the D elements are indexed as D_{n,m}. The result matrix may represent an accumulation of the third matrix 1909 with a product matrix generated from a matrix multiplication using the first matrix 1905 and the second matrix 1907. This may be done as described elsewhere herein (e.g., for FIG. 1), for example, optionally with conversion, optionally with rounding as needed, and so on. The execution circuitry may also store the result matrix in the 128-bit lane of the third vector register. For example, the result matrix may overwrite the third matrix in the 128-bit lane of the third vector register.

In some embodiments, the 32-bit data elements of the first and second matrices may each be TF32 data elements. In some embodiments, the 32-bit data elements of the third and fourth matrices may each be single precision floating-point (F32) data elements. In some embodiments each vector register may optionally include more than one 128-bit lane (e.g., two, four, eight, or some other number of 128-bit lanes) with each 128-bit lane storing a respective matrix and the operations may further include performing a separate multiplication and accumulation operation similar to the one described on these different lanes of matrices. In some embodiments, the vector packed matrix multiplication and accumulation instruction 1901 may be the VMMTF32PS instruction described further below, and the execution circuitry may perform any of the operations described for the VMMTF32PS instruction further below.

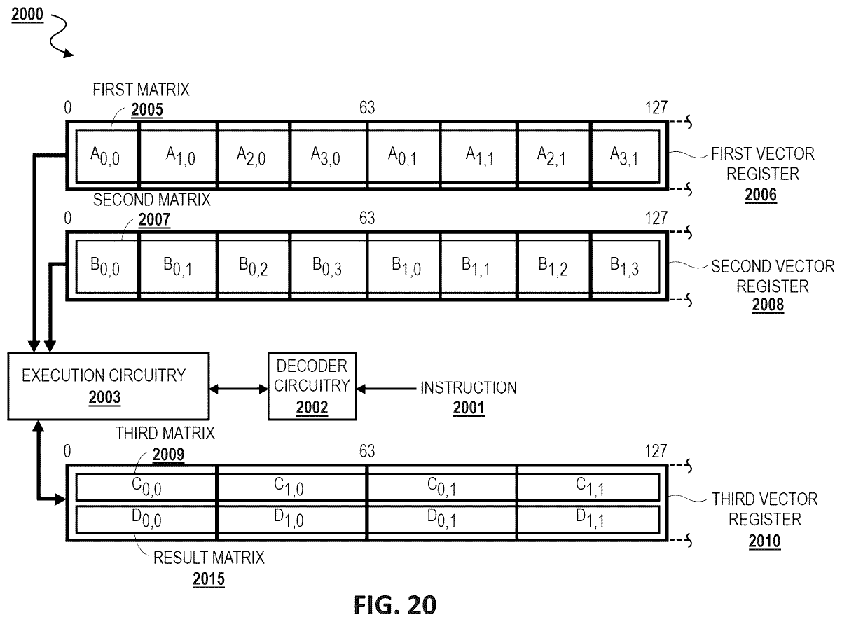

FIG. 20 is a block diagram of an embodiment of a processor 2000 to perform a vector packed matrix multiplication and accumulation instruction 2001 to perform vector packed matrix multiplication and accumulation operations using a first matrix 2005 and a second matrix 2007 both having 16-bit data elements. The processor includes a decoder circuitry 2002 to decode the vector packed matrix multiplication and accumulation instruction. The decoder circuitry may be similar to, or the same as, the decoder circuitry 1802 described for FIG. 18. The instruction may specify or otherwise indicate a first vector register 2006 having a 128-bit lane storing the first matrix 2005, a second vector register 2008 having a 128-bit lane storing the second matrix 2007, and a third vector register 2010 having a 128-bit lane storing a third matrix 2009.

For these 16-bit data elements, the first and second matrices have common dimension K=4 (e.g., K=4=64/16). The first matrix has eight 16-bit data elements, arranged in two rows by four columns, labeled A_{0,0} in bits [15:0], A_{1,0} in bits [31:16], A_{2,0} in bits [47:32], A_{3,0} in bits [63:48], A_{0,1} in bits [79:64], A_{1,1} in bits [95:80], A_{2,1} in bits [111:96], and A_{3,1} in bits [127:112], where the A elements are indexed as A_{k,m}. The second matrix has eight 16-bit data elements, arranged in four rows by two columns, labeled B_{0,0} in bits [15:0], B_{0,1} in bits [31:16], B_{0,2} in bits [47:32], B_{0,3} in bits [63:48], B_{1,0} in bits [79:64], B_{1,1} in bits [95:80], B_{1,2} in bits [111:96], and B_{1,3} in bits [127:112], where the B elements are indexed as B_{n,k}. The third matrix has four 32-bit data elements, arranged in two rows by two columns, labeled C_{0,0} in bits [31:0], C_{1,0} in bits [63:32], C_{0,1} in bits [95:64], and C_{1,1} in bits [127:96], where the C elements are indexed as C_{n,m}. This arrangement of the 16-bit and 32-bit data elements within the matrices may tend to be more efficient than certain other arrangements (e.g., in terms of managing the smaller matrices as part of an overall algorithm of multiplying and accumulating larger matrices), although other arrangements may optionally be used, if desired.

Execution circuitry 2003 is coupled with the decoder circuitry 2002. The execution circuitry may perform vector packed matrix multiplication and accumulation operations corresponding to the instruction. These operations may include generating a result matrix 2015. The result matrix may have four 32-bit data elements, arranged in two rows by two columns, labeled D_{0,0} in bits [31:0], D_{1,0} in bits [63:32], D_{0,1} in bits [95:64], and D_{1,1} in bits [127:96], where the D elements are indexed as D_{n,m}. The result matrix may represent an accumulation of the third matrix 2009 with a product matrix generated from a matrix multiplication using the first matrix 2005 and the second matrix 2007. This may be done as described elsewhere herein (e.g., for FIG. 1), for example, optionally with conversion, optionally with rounding as needed, and so on. The execution circuitry may also store the result matrix in the 128-bit lane of the third vector register. For example, the result matrix may overwrite the third matrix in the 128-bit lane of the third vector register.

In some embodiments, the 16-bit data elements of the first and second matrices may each be bfloat16 (BF16) data elements. In other embodiments, the 16-bit data elements of the first and second matrices may each be half precision floating-point (float16 or F16) data elements. In some embodiments, the 32-bit data elements of the third and fourth matrices may each be single precision floating-point (F32) data elements. In some embodiments each vector register may optionally include more than one 128-bit lane (e.g., two, four, eight, or some other number of 128-bit lanes) with each 128-bit lane storing a respective matrix and the operations may further include performing a separate multiplication and accumulation operation similar to the one described on these different lanes of matrices. In some embodiments, the vector packed matrix multiplication and accumulation instruction 2001 may be the VMMBF16PS instruction described further below, and the execution circuitry may perform any of the operations described for the VMMBF16PS instruction further below. In other embodiments, the vector packed matrix multiplication and accumulation instruction 2001 may be the VMMF16PS instruction described further below, and the execution circuitry may perform any of the operations described for the VMMF16PS instruction further below.

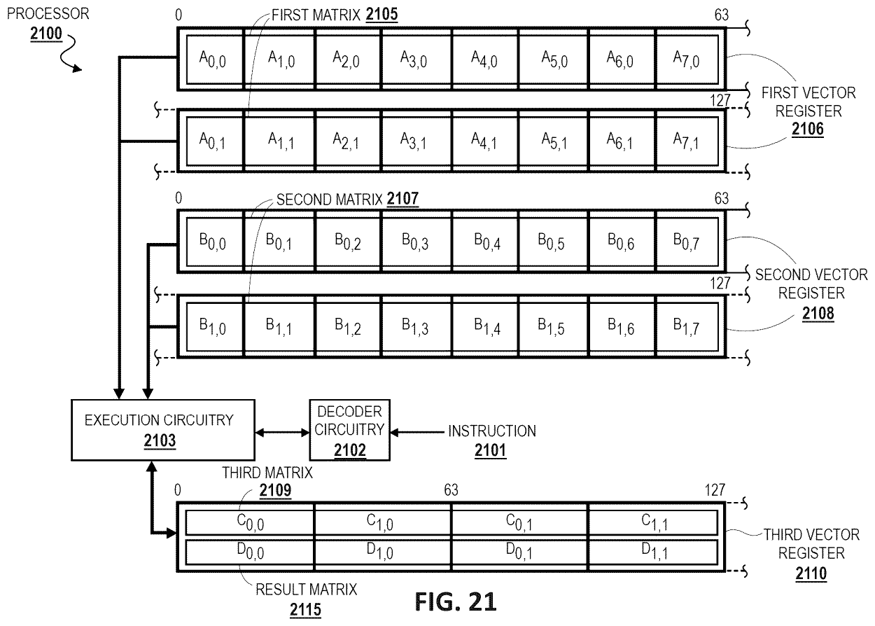

FIG. 21 is a block diagram of an embodiment of a processor 2100 to perform a vector packed matrix multiplication and accumulation instruction 2101 to perform vector packed matrix multiplication and accumulation operations using a first matrix 2105 and a second matrix 2107 both having 8-bit data elements. The processor includes a decoder circuitry 2102 to decode the vector packed matrix multiplication and accumulation instruction. The decoder circuitry may be similar to, or the same as, the decoder circuitry 1802 described for FIG. 18. The instruction may specify or otherwise indicate a first vector register 2106 having a 128-bit lane storing the first matrix 2105, a second vector register 2108 having a 128-bit lane storing the second matrix 2107, and a third vector register 2110 having a 128-bit lane storing a third matrix 2109.

For these 8-bit data elements, the first and second matrices have common dimension K=8 (e.g., K=8=64/8). The first matrix has sixteen 8-bit data elements, arranged in two rows by eight columns, labeled A_{0,0} in bits [7:0], A_{1,0} in bits [15:8], A_{2,0} in bits [23:16], A_{3,0} in bits [31:24], A_{4,0} in bits [39:32], A_{5,0} in bits [47:40], A_{6,0} in bits [55:48], and A_{7,0} in bits [63:56], A_{0,1} in bits [71:64], A_{1,1} in bits [79:72], A_{2,1} in bits [87:80], A_{3,1} in bits [95:88], A_{4,1} in bits [103:96], A_{5,1} in bits [111:104], A_{6,1} in bits [119:112], and A_{7,1} in bits [127:120], where the A elements are indexed as A_{k,m}. The second matrix has sixteen 8-bit data elements, arranged in eight rows by two columns, labeled B_{0,0} in bits [7:0], B_{0,1} in bits [15:8], B_{0,2} in bits [23:16], B_{0,3} in bits [31:24], B_{0,4} in bits [39:32], B_{0,5} in bits [47:40], B_{0,6} in bits [55:48], B_{0,7} in bits [63:56], B_{1,0} in bits [71:64], B_{1,1} in bits [79:72], B_{1,2} in bits [87:80], B_{1,3} in bits [95:88], B_{1,4} in bits [103:96], B_{1,5} in bits [111:104], B_{1,6} in bits [119:112], and B_{1,7} in bits [127:120], where the B elements are indexed as B_{n,k}. The third matrix has four 32-bit data elements, arranged in two rows by two columns, labeled C_{0,0} in bits [31:0], C_{1,0} in bits [63:32], C_{0,1} in bits [95:64], and C_{1,1} in bits [127:96], where the C elements are indexed as C_{n,m}. This arrangement of the 8-bit and 32-bit data elements within the matrices may tend to be more efficient than certain other arrangements (e.g., in terms of managing the smaller matrices as part of an overall algorithm of multiplying and accumulating larger matrices), although other arrangements may optionally be used, if desired.

Execution circuitry 2103 is coupled with the decoder circuitry 2102. The execution circuitry may perform vector packed matrix multiplication and accumulation operations corresponding to the instruction. These operations may include generating a result matrix 2115. The result matrix may have four 32-bit data elements, arranged in two rows by two columns, labeled D_{0,0} in bits [31:0], D_{1,0} in bits [63:32], D_{0,1} in bits [95:64], and D_{1,1} in bits [127:96], where the D elements are indexed as D_{n,m}. The result matrix may represent an accumulation of the third matrix 2109 with a product matrix generated from a matrix multiplication using the first matrix 2105 and the second matrix 2107. This may be done as described elsewhere herein (e.g., for FIG. 18), for example, optionally with conversion, optionally with rounding as needed, and so on. The execution circuitry may also store the result matrix in the 128-bit lane of the third vector register. For example, the result matrix may overwrite the third matrix in the 128-bit lane of the third vector register.

In some embodiments, the 8-bit data elements of the first and second matrices may each be bfloat8 (BF8) data elements. In other embodiments, the 8-bit data elements of the first and second matrices may each be hfloat8 (HF8) data elements. In other embodiments, the 8-bit data elements of the first matrix may each be bfloat8 (BF8) data elements and the 8-bit data elements of the first matrix may each be hfloat8 (HF8) data elements. In other embodiments, the 8-bit data elements of the first matrix may each be hfloat8 (HF8) data elements and the 8-bit data elements of the first matrix may each be bfloat8 (BF8) data elements. In any of the above embodiments of this paragraph, the 32-bit data elements of the third and fourth matrices may each be single precision floating-point (F32) data elements.

In still other embodiments, the 8-bit data elements of the first and second matrices may each be 8-bit signed integer (S8) data elements. In other embodiments, the 8-bit data elements of the first and second matrices may each be 8-bit unsigned integer (U8) data elements. In other embodiments, the 8-bit data elements of the first matrix may each be 8-bit signed integer (S8) data elements and the 8-bit data elements of the first matrix may each be 8-bit unsigned integer (U8) data elements. In other embodiments, the 8-bit data elements of the first matrix may each be 8-bit unsigned integer (U8) data elements and the 8-bit data elements of the first matrix may each be 8-bit signed integer (S8) data elements. In any of the above embodiments of this paragraph, the 32-bit data elements of the third and fourth matrices may each be 32-bit signed integer (int32) data elements. In some embodiments each vector register may optionally include more than one 128-bit lane (e.g., two, four, eight, or some other number of 128-bit lanes) with each 128-bit lane storing a respective matrix and the operations may further include performing a separate multiplication and accumulation operation similar to the one described on these different lanes of matrices. In some embodiments, the vector packed matrix multiplication and accumulation instruction 2101 may be any one of the VPMMUUBD, VPMMSSBD, VPMMUSBD, VPMMSUBD, VMMBF8PS, VMMHF8PS, VMMBHF8PS, and VMMHBF8PS instructions described further below, and the execution circuitry may perform any of the operations described for any one of these instructions further below.

Described below are example embodiments of instructions. These instructions are labeled as VMMTF32PS, VMM [BF16,F16] PS, VPMM [UU,SS,US,SU] BD, and VMM [B,H,BH,HB] F8PS. In some embodiments, VMM [BF16,F16] PS may be two separate instructions (e.g., one instruction for BF16 and another instruction for F16), whereas in other embodiments it may be one instruction with an immediate, field, or operand to select or indicate one of BF16 and F16. Likewise, in some embodiments, VPMM [UU,SS,US,SU] BD may be four separate instructions (e.g., one instruction for each of UU, SS, US, and SU), whereas in other embodiments it may be one instruction with an immediate, field, or operand to select or indicate one of UU, SS, US, and SU. Similarly, in some embodiments, VMM [B,H,BH,HB] F8PS may be four separate instructions (e.g., one instruction for each of B, H, BH, and HB), whereas in other embodiments it may be one instruction with an immediate, field, or operand to select or indicate one of B, H, BH, and HB.

In the pseudocode below, “src1” designates a first source operand, “src2” designates a second source operand, “DEST” designates a destination operand, “srcdest” designates a source operand that is implicitly reused as a destination operand, and “TMP” designates a temporary value produced during the operation. Further, “xmm,” “ymm,” and “zmm,” respectively designates 128-bit, 256-bit, and 512-bit registers in the x86 instruction set architecture (ISA). These broadly represent 128-bit, 256-bit, and 512-bit registers. “ModRM:reg(r,w),” “ModRM:11:rrr:bbb,” “VEX.vvvv(r),” and “ModRM:reg(r)” designate operand addressing modes used in the x86 ISA. The first two set bits “11” of ModRM: 11:rrr:bbb designates register/register access in cases where operands are optionally only allowed to be in registers not memory, which is not required for other embodiments. “VL” (e.g., as in “VL=128”) designates a vector length, whereas “KL” designates a number of 128-bit segments lanes in the vector of vector length VL. The “FOR” (e.g., as in “FOR n: =0 to x”) designates the beginning of a loop over a certain number of iterations (e.g., x+1 iterations). The symbol “:=” designates to assign the value on the right-hand side to the variable on the left-hand side. The notation “[x:0]” designates a range of bit positions. For example, “src1[127:0]” designates the bit positions of bits 0 to 127 of src1, the [31:0] in “TMP1.fp32[31:0]” designates bits 0 to 31 of TMP1.fp32, and so on. The asterisk “*” symbol designates multiplication. Two backslashes “//” precede a comment about the pseudocode. The “RET” designates a return (e.g., storage of a destination operand to the destination register).

Also, in the pseudocode below, the following designate how data elements are accessed or addressed: (1) .128b designates interpreting vector elements as 128 bits wide; (2) .fp32 designates interpreting a vector element as a F32 (float32) value; (3) .tf32 designates interpreting a vector element as a TF32 (tensor-float32) value; (4) .bf16 designates interpreting a vector element as a BF16 (bfloat16) value; (5) .fp16 designates interpreting a vector element as a F16 (float16) value; (6) .bf8 designates interpreting a vector element as a BF8 (bfloat8) value; (7) .hf8 designates interpreting a vector element as an HF8 (hfloat8) value; (8) .i32 designates interpreting a vector element as an I32 (signed int32) value; (9) .s8 designates interpreting a vector element as an S8 (signed int8) value; and (10) .u8 designates interpreting a vector element as a U8 (unsigned int8) value.

VMMTF32PS Instruction: One or more 128-bit lanes of packed TF32 small matrix multiplication: Each 128-bit lane in src1 and src2 is interpreted as a 2×2 (A) or 2×2 (B) matrix, and the A and B matrices in the corresponding 128-bit lanes are matrix multiplied with each other. The result is a 2×2 intermediate matrix in FP32 whose elements are added with the corresponding elements of the accumulation matrix in the srcdest.

```
VL=128 VMMTF32PS xmm1, xmm2, xmm3
VL=256 VMMTF32PS ymm1, ymm2, ymm3
VL=512 VMMTF32PS zmm1, zmm2, zmm3
Operand 1: ModRM:reg(r,w)
Operand 2: VEX.vvvv(r)
Operand 3: ModRM:reg(r)
      VMMTF32PS dest, src1, src2
VL=(128,256,512)
KL=VL/128
FOR i := 0 to KL-1:
  TMP[127:0] := tf32fp32_2×2×2_matmul(src1.128b[i], src2.128b[i])
  FOR j := 0 to 3:
    dest.fp32[i*4 + j] := dest.fp32[i*4 + j] + TMP.fp32[j]
DEST[MAX_VL-1:VL] := 0
```

Pseudocode Operation tf32fp32_2×2×2_matmul (src1[127:0], src2[127:0])

```
DEST[127:0] = 0
FOR n := 0 to 1:
  FOR m := 0 to 1:
    P0[31:0] := TF32FP32Mul(src1.tf32[m*2+0], src2.tf32[n*2+0])
    P1[31:0] := TF32FP32Mul(src1.tf32[m*2+1], src2.tf32[n*2+1])
  DEST.fp32[m*2+n] := P0.fp32[31:0] + P1.fp32[31:0];
RET DEST
```

TF32FP32Mul represents a scalar multiplication of two TF32 elements to generate FP32 product. In some embodiments, the source data elements may optionally be converted to larger (e.g., higher-precision) data elements (e.g., 32-bit single-precision floating-point data elements). The operation may also implement floating-point rounding as needed, handle denormals (e.g., whether to FTZ, whether to DAZ) as needed, propagate NaN and infinity as needed.

VMM[BF16/F16] PS Instructions: One or more 128-bit lanes of packed BF16 and/or FP16 small matrix multiplication: Each 128-bit lane in src1 and src2 is interpreted as a 2×4 (A) or 4×2 (B) matrix, and the A and B matrices in the corresponding 128-bit lanes are matrix multiplied with each other. The result is an intermediate 2×2 matrix in FP32 whose elements are added with the corresponding elements of the accumulation matrix in the srcdest.

```
VL=128 VMM[BF16/F16]PS xmm1, xmm2, xmm3
VL=256 VMM[BF16/F16]PS ymm1, ymm2, ymm3
VL=512 VMM[BF16/F16]PS zmm1, zmm2, zmm3
Operand 1: ModRM:reg(r,w)
Operand 2: c(r)
Operand 3: ModRM:reg(r)
    VMMBF16PS dest, src1, src2
VL=(128,256,512)
KL=VL/128
FOR i := 0 to KL-1:
  TMP[127:0] := bf16fp32_2×2×4_matmul(src1.128b[i], src2.128b[i])
  FOR j := 0 to 3:
      dest.fp32[i*4 + j] := dest.fp32[i*4 + j] + TMP.fp32[j]
DEST[MAX_VL-1:VL] := 0
```

Pseudocode Operation bf16fp32_2×2×4_matmul (src1[127:0], src2[127:0])

```
DEST[127:0] = 0
FOR n := 0 to 1:
  FOR m := 0 to 1:
    P0[31:0] := BF16FP32Mul(src1.bf16[m*4+0], src2.bf16[n*4+0])
    P1[31:0] := BF16FP32Mul(src1.bf16[m*4+1], src2.bf16[n*4+1])
    P2[31:0] := BF16FP32Mul(src1.bf16[m*4+2], src2.bf16[n*4+2])
    P3[31:0] := BF16FP32Mul(src1.bf16[m*4+3], src2.bf16[n*4+3])
    TMP0[31:0] = P0.fp32[31:0] + P2.fp32[31:0];
    TMP1[31:0] = P1.fp32[31:0] + P3.fp32[31:0];
    DEST.fp32[m*2+n] := TMP0.fp32[31:0] + TMP1.fp32[31:0];
RET DEST
```

BF16FP32Mul represents a scalar multiplication of two BF16 elements to generate FP32 product. In some embodiments, the source data elements may optionally be converted to larger (e.g., higher-precision) data elements (e.g., 32-bit single-precision floating-point data elements). The operation may also implement floating-point rounding as needed, handle denormals (e.g., whether to FTZ, whether to DAZ) as needed, propagate NaN and infinity as needed.

```
      VMMF16PS dest, src1, src2
VL=(128,256,512)
KL=VL/128
FOR i := 0 to KL-1:
  TMP[127:0] := f16fp32_2×2×4_matmul(src1.128b[i], src2.128b[i])
  FOR j := 0 to 3:
    dest.fp32[i*4 + j] := dest.fp32[i*4 + j] + TMP.fp32[j]
DEST[MAX_VL-1:VL] := 0
```

Pseudocode Operation f16fp32_2×2×4_matmul (src1[127:0], src2[127:0])

```
DEST[127:0] = 0
FOR n := 0 to 1:
  FOR m := 0 to 1:
    P0[31:0] := F16FP32Mul(src1.f16[m*4+0], src2.f16[n*4+0])
    P1[31:0] := F16FP32Mul(src1.f16[m*4+1], src2.f16[n*4+1])
    P2[31:0] := F16FP32Mul(src1.f16[m*4+2], src2.f16[n*4+2])
    P3[31:0] := F16FP32Mul(src1.f16[m*4+3], src2.f16[n*4+3])
    TMP0[31:0] = P0.fp32[31:0] + P2.fp32[31:0];
    TMP1[31:0] = P1.fp32[31:0] + P3.fp32[31:0];
    DEST.fp32[m*2+n] := TMP0.fp32[31:0] + TMP1.fp32[31:0];
RET DEST
```

F16FP32Mul represents a scalar multiplication of two FP16 elements to generate FP32 product. In some embodiments, the source data elements may optionally be converted to larger (e.g., higher-precision) data elements (e.g., 32-bit single-precision floating-point data elements). The operation may also implement floating-point rounding as needed, handle denormals (e.g., whether to FTZ, whether to DAZ) as needed, propagate NaN and infinity as needed.

VPMM[UU/SS/US/SU] BD Instructions: One or more 128-bit lanes of packed unsigned-unsigned, signed-signed, unsigned-signed, or signed-unsigned 8-bit integer small matrix multiplication: Each 128-bit lane in src1 and src2 is interpreted as a 2×8 (A) or 8×2 (B) matrix, and the A and B matrices in the corresponding 128-bit lanes are matrix multiplied with each other. A and B can be either signed or unsigned int8. The result is an intermediate 2×2 matrix in int32 whose elements are added with the corresponding elements of the accumulation matrix in the srcdest.

```
VL=128 VPMM[UU/SS/US/SU]BD xmm1, xmm2, xmm3
VL=256 VPMM[UU/SS/US/SU]BD ymm1, ymm2, ymm3
VL=512 VPMM[UU/SS/US/SU]BD zmm1, zmm2, zmm3
Operand 1: ModRM:reg(r,w)
Operand 2: VEX.vvvv(r)
Operand 3: ModRM:reg(r)
      VPMMUUBD dest, src1, src2
VL=(128,256,512)
KL=VL/128
FOR i := 0 to KL-1:
  TMP[127:0] := uu8i32_2×2×8_matmul(src1.128b[i], src2.128b[i])
  FOR j := 0 to 3:
    dest.i32[i*4 + j] := dest.i32[i*4 + j] + TMP.i32[j]
DEST[MAX_VL-1:VL] := 0
```

Pseudocode Operation uu8132_2×2×8_matmul (src1[127:0], src2[127:0])

```
DEST[127:0] = 0
FOR n := 0 to 1:
  FOR m := 0 to 1:
    P0[31:0] := UU8I32Mul(src1.u8[m*8+0], src2.u8[n*8+0])
    P1[31:0] := UU8I32Mul(src1.u8[m*8+1], src2.u8[n*8+1])
    P2[31:0] := UU8I32Mul(src1.u8[m*8+2], src2.u8[n*8+2])
    P3[31:0] := UU8I32Mul(src1.u8[m*8+3], src2.u8[n*8+3])
    P4[31:0] := UU8I32Mul(src1.u8[m*8+4], src2.u8[n*8+4])
    P5[31:0] := UU8I32Mul(src1.u8[m*8+5], src2.u8[n*8+5])
    P6[31:0] := UU8I32Mul(src1.u8[m*8+6], src2.u8[n*8+6])
    P7[31:0] := UU8I32Mul(src1.u8[m*8+7], src2.u8[n*8+7])
// no order required since non-saturating addition (e.g., FP8 order)
DEST.i32[m*2+n] := int32_reduce_nonsat( P0, P1, P2, P3, P4, P5, P6,
P7 )
```

UU8I32Mul represents a scalar multiplication of two U8 elements to generate 132 product. In some embodiments, the source data elements may optionally be converted to larger (e.g., higher-precision) data elements (e.g., 32-bit integer data elements).

```
      VPMMSSBD dest, src1, src2
VL=(128,256,512)
KL=VL/128
FOR i := 0 to KL-1:
  TMP[127:0] := ss8i32_2×2×8_matmul(src1.128b[i], src2.128b[i])
  FOR j := 0 to 3:
    dest.i32[i*4 + j] := dest.i32[i*4 + j] + TMP.i32[j]
DEST[MAX_VL-1:VL] := 0
```

Pseudocode Operation ss8i32_2×2×8_matmul (src1[127:0], src2[127:0])

```
DEST[127:0] = 0
FOR n := 0 to 1:
  FOR m := 0 to 1:
    P0[31:0] := SS8I32Mul(src1.s8[m*8+0], src2.s8[n*8+0])
    P1[31:0] := SS8I32Mul(src1.s8[m*8+1], src2.s8[n*8+1])
    P2[31:0] := SS8I32Mul(src1.s8[m*8+2], src2.s8[n*8+2])
    P3[31:0] := SS8I32Mul(src1.s8[m*8+3], src2.s8[n*8+3])
    P4[31:0] := SS8I32Mul(src1.s8[m*8+4], src2.s8[n*8+4])
    P5[31:0] := SS8I32Mul(src1.s8[m*8+5], src2.s8[n*8+5])
    P6[31:0] := SS8I32Mul(src1.s8[m*8+6], src2.s8[n*8+6])
    P7[31:0] := SS8I32Mul(src1.s8[m*8+7], src2.s8[n*8+7])
// no order required since non-saturating addition (e.g., FP8 order)
DEST.i32[m*2+n] := int32_reduce_nonsat( P0, P1, P2, P3, P4, P5, P6,
P7 )
```

SS8I32Mul represents a scalar multiplication of two S8 elements to generate 132 product. In some embodiments, the source data elements may optionally be converted to larger (e.g., higher-precision) data elements (e.g., 32-bit integer data elements).

```
      VPMMUSBD dest, src1, src2
VL=(128,256,512)
KL=VL/128
FOR i := 0 to KL-1:
  TMP[127:0] := us8i32_2×2×8_matmul(src1.128b[i], src2.128b[i])
  FOR j := 0 to 3:
    dest.i32[i*4 + j] := dest.i32[i*4 + j] + TMP.i32[j]
DEST[MAX_VL-1:VL] := 0
```

Pseudocode Operation us8i32_2×2×8_matmul (src1[127:0], src2[127:0])

```
DEST[127:0] = 0
FOR n := 0 to 1:
  FOR m := 0 to 1:
    P0[31:0] := US8I32Mul(src1.u8[m*8+0], src2.s8[n*8+0])
    P1[31:0] := US8I32Mul(src1.u8[m*8+1], src2.s8[n*8+1])
    P2[31:0] := US8I32Mul(src1.u8[m*8+2], src2.s8[n*8+2])
    P3[31:0] := US8I32Mul(src1.u8[m*8+3], src2.s8[n*8+3])
    P4[31:0] := US8I32Mul(src1.u8[m*8+4], src2.s8[n*8+4])
    P5[31:0] := US8I32Mul(src1.u8[m*8+5], src2.s8[n*8+5])
    P6[31:0] := US8I32Mul(src1.u8[m*8+6], src2.s8[n*8+6])
    P7[31:0] := US8I32Mul(src1.u8[m*8+7], src2.s8[n*8+7])
// no order required since non-saturating addition (e.g., FP8 order)
DEST.i32[m*2+n] := int32_reduce_nonsat( P0, P1, P2, P3, P4, P5, P6,
P7 )
```

US8I32Mul represents a scalar multiplication of U8 and S8 elements to generate 132 product. In some embodiments, the source data elements may optionally be converted to larger (e.g., higher-precision) data elements (e.g., 32-bit integer data elements).

```
      VPMMSUBD dest, src1, src2
VL=(128,256,512)
KL=VL/128
FOR i := 0 to KL-1:
  TMP[127:0] := su8i32_2×2×8_matmul(src1.128b[i], src2.128b[i])
  FOR j := 0 to 3:
    dest.i32[i*4 + j] := dest.i32[i*4 + j] + TMP.i32[j]
DEST[MAX_VL-1:VL] := 0
```

Pseudocode Operation su8i32_2×2×8_matmul (src1[127:0], src2[127:0])

```
DEST[127:0] = 0
FOR n := 0 to 1:
  FOR m := 0 to 1:
    P0[31:0] := SU8I32Mul(src1.s8[m*8+0], src2.u8[n*8+0])
    P1[31:0] := SU8I32Mul(src1.s8[m*8+1], src2.u8[n*8+1])
    P2[31:0] := SU8I32Mul(src1.s8[m*8+2], src2.u8[n*8+2])
    P3[31:0] := SU8I32Mul(src1.s8[m*8+3], src2.u8[n*8+3])
    P4[31:0] := SU8I32Mul(src1.s8[m*8+4], src2.u8[n*8+4])
    P5[31:0] := SU8I32Mul(src1.s8[m*8+5], src2.u8[n*8+5])
    P6[31:0] := SU8I32Mul(src1.s8[m*8+6], src2.u8[n*8+6])
    P7[31:0] := SU8I32Mul(src1.s8[m*8+7], src2.u8[n*8+7])
// no order required since non-saturating addition (e.g., FP8 order)
DEST.i32[m*2+n] := int32_reduce_nonsat( P0, P1, P2, P3, P4, P5, P6,
P7 )
```

SU8I32Mul represents a scalar multiplication of S8 and U8 elements to generate 132 product. In some embodiments, the source data elements may optionally be converted to larger (e.g., higher-precision) data elements (e.g., 32-bit integer data elements).

VMM[B/H/BH/HB]F8PS Instructions: One or more 128-bit lanes of packed 8-bit floating-point small matrix multiplication: Each 128-bit lane in src1 and src2 is interpreted as a 2×8 (A) or 8×2 (B) matrix, and the A and B matrices in the corresponding 128-bit lanes are matrix multiplied with each other. The A and B matrices can independently of the other have either BF8 (also known as E5M2 having five exponent bits and two explicit mantissa bits) elements or HF8 (also known as E4M3 having four exponent bits and three explicit significand bits) elements. The result is an intermediate 2×2 matrix in FP32 whose elements are added with the corresponding elements of the accumulation matrix in the srcdest.

```
VL=128 VMM[B/H/BH/HB]F8PS xmm1, xmm2, xmm3
VL=256 VMM[B/H/BH/HB]F8PS ymm1, ymm2, ymm3
VL=512 VMM[B/H/BH/HB]F8PS zmm1, zmm2, zmm3
Operand 1: ModRM:reg(r,w)
Operand 2: VEX.vvvv(r)
Operand 3: ModRM:reg(r)
      VMMBF8PS dest, src1, src2
VL=(128,256,512)
KL=VL/128
FOR i := 0 to KL-1:
  TMP[127:0] := bf8fp32_2×2×8_matmul(src1.128b[i], src2.128b[i])
  FOR j := 0 to 3:
    dest.fp32[i*4 + j] := dest.fp32[i*4 + j] + TMP.fp32[j]
DEST[MAX_VL-1:VL] := 0
```

Pseudocode Operation bf8fp32_2×2×8_matmul (src1[127:0], src2[127:0])

```
DEST[127:0] = 0
FOR n := 0 to 1:
  FOR m := 0 to 1:
    P0e.fp32[31:0] := BF8FP32Mul(src1.bf8[m*8+0], src2.bf8[n*8+0])
    P0o.fp32[31:0] := BF8FP32Mul(src1.bf8[m*8+1], src2.bf8[n*8+1])
    P1e.fp32[31:0] := BF8FP32Mul(src1.bf8[m*8+2], src2.bf8[n*8+2])
    P1o.fp32[31:0] := BF8FP32Mul(src1.bf8[m*8+3], src2.bf8[n*8+3])
    P2e.fp32[31:0] := BF8FP32Mul(src1.bf8[m*8+4], src2.bf8[n*8+4])
    P2o.fp32[31:0] := BF8FP32Mul(src1.bf8[m*8+5], src2.bf8[n*8+5])
    P3e.fp32[31:0] := BF8FP32Mul(src1.bf8[m*8+6], src2.bf8[n*8+6])
    P3o.fp32[31:0] := BF8FP32Mul(src1.bf8[m*8+7], src2.bf8[n*8+7])
  // Column Horizontal Reductions
  TMP0e.fp32[31:0] := P0e.fp32[31:0] + P0o.fp32[31:0];
  TMP0o.fp32[31:0] := P1e.fp32[31:0] + P1o.fp32[31:0];
  TMP1e.fp32[31:0] := P2e.fp32[31:0] + P2o.fp32[31:0];
  TMP1o.fp32[31:0] := P3e.fp32[31:0] + P3o.fp32[31:0];
  // Vertical Reduction
  TMP0.fp32[31:0] := TMP0e.fp32[31:0] + TMP1e.fp32[31:0];
  TMP1.fp32[31:0] := TMP0o.fp32[31:0] + TMP1o.fp32[31:0];
  // Horizontal Reduction
  DEST.fp32[m*2+n] := TMP0.fp32[31:0] + TMP1.fp32[31:0];
RET DEST
```

BF8FP32Mul represents a scalar multiplication of two BF8 elements to generate FP32 product. In some embodiments, the source data elements may optionally be converted to larger (e.g., higher-precision) data elements (e.g., 32-bit single-precision floating-point data elements). The operation may also implement floating-point rounding as needed, handle denormals (e.g., whether to FTZ, whether to DAZ) as needed, propagate NaN and infinity as needed.

```
      VMMHF8PS dest, src1, src2
VL=(128,256,512)
KL=VL/128
FOR i := 0 to KL-1:
  TMP[127:0] := hf8fp32_2×2×8_matmul(src1.128b[i], src2.128b[i])
  FOR j := 0 to 3:
    dest.fp32[i*4 + j] := dest.fp32[i*4 + j] + TMP.fp32[j]
DEST[MAX_VL-1:VL] := 0
```

Pseudocode Operation hf8fp32_2×2×8_matmul (src1[127:0], src2[127:0])

```
DEST[127:0] = 0
FOR n := 0 to 1:
  FOR m := 0 to 1:
    P0e.fp32[31:0] := HF8FP32Mul(src1.hf8[m*8+0], src2.hf8[n*8+0])
    P0o.fp32[31:0] := HF8FP32Mul(src1.hf8[m*8+1], src2.hf8[n*8+1])
    P1e.fp32[31:0] := HF8FP32Mul(src1.hf8[m*8+2], src2.hf8[n*8+2])
    P1o.fp32[31:0] := HF8FP32Mul(src1.hf8[m*8+3], src2.hf8[n*8+3])
    P2e.fp32[31:0] := HF8FP32Mul(src1.hf8[m*8+4], src2.hf8[n*8+4])
    P2o.fp32[31:0] := HF8FP32Mul(src1.hf8[m*8+5], src2.hf8[n*8+5])
    P3e.fp32[31:0] := HF8FP32Mul(src1.hf8[m*8+6], src2.hf8[n*8+6])
    P3o.fp32[31:0] := HF8FP32Mul(src1.hf8[m*8+7], src2.hf8[n*8+7])
  // Column Horizontal Reductions
  TMP0e.fp32[31:0] := P0e.fp32[31:0] + P0o.fp32[31:0];
  TMP0o.fp32[31:0] := P1e.fp32[31:0] + P1o.fp32[31:0];
  TMP1e.fp32[31:0] := P2e.fp32[31:0] + P2o.fp32[31:0];
  TMP1o.fp32[31:0] := P3e.fp32[31:0] + P3o.fp32[31:0];
  // Vertical Reduction
  TMP0.fp32[31:0] := TMP0e.fp32[31:0] + TMP1e.fp32[31:0];
  TMP1.fp32[31:0] := TMP0o.fp32[31:0] + TMP1o.fp32[31:0];
  // Horizontal Reduction
  DEST.fp32[m*2+n] := TMP0.fp32[31:0] + TMP1.fp32[31:0];
RET DEST
```

HF8FP32Mul represents a scalar multiplication of two HF8 elements to generate FP32 product. In some embodiments, the source data elements may optionally be converted to larger (e.g., higher-precision) data elements (e.g., 32-bit single-precision floating-point data elements). The operation may also implement floating-point rounding as needed, handle denormals (e.g., whether to FTZ, whether to DAZ) as needed, propagate NaN and infinity as needed.

```
      VMMBHF8PS dest, src1, src2
VL=(128,256,512)
KL=VL/128
FOR i := 0 to KL-1:
  TMP[127:0] := bhf8fp32_2×2×8_matmul(src1.128b[i], src2.128b[i])
  FOR j := 0 to 3:
    dest.fp32[i*4 + j] := dest.fp32[i*4 + j] + TMP.fp32[j]
DEST[MAX_VL-1:VL] := 0
```

Pseudocode Operation bhf8fp32_2×2×8_matmul (src1[127:0], src2[127:0])

```
DEST[127:0] = 0
FOR n := 0 to 1:
  FOR m := 0 to 1:
    P0e.fp32[31:0] := BHF8FP32Mul(src1.bf8[m*8+0], src2.hf8[n*8+0])
    P0o.fp32[31:0] := BHF8FP32Mul(src1.bf8[m*8+1], src2.hf8[n*8+1])
    P1e.fp32[31:0] := BHF8FP32Mul(src1.bf8[m*8+2], src2.hf8[n*8+2])
    P1o.fp32[31:0] := BHF8FP32Mul(src1.bf8[m*8+3], src2.hf8[n*8+3])
    P2e.fp32[31:0] := BHF8FP32Mul(src1.bf8[m*8+4], src2.hf8[n*8+4])
    P2o.fp32[31:0] := BHF8FP32Mul(src1.bf8[m*8+5], src2.hf8[n*8+5])
    P3e.fp32[31:0] := BHF8FP32Mul(src1.bf8[m*8+6], src2.hf8[n*8+6])
    P3o.fp32[31:0] := BHF8FP32Mul(src1.bf8[m*8+7], src2.hf8[n*8+7])
  // Column Horizontal Reductions
  TMP0e.fp32[31:0] := P0e.fp32[31:0] + P0o.fp32[31:0];
  TMP0o.fp32[31:0] := P1e.fp32[31:0] + P1o.fp32[31:0];
  TMP1e.fp32[31:0] := P2e.fp32[31:0] + P2o.fp32[31:0];
  TMP1o.fp32[31:0] := P3e.fp32[31:0] + P3o.fp32[31:0];
  // Vertical Reduction
  TMP0.fp32[31:0] := TMP0e.fp32[31:0] + TMP1e.fp32[31:0];
  TMP1.fp32[31:0] := TMP0o.fp32[31:0] + TMP1o.fp32[31:0];
  // Horizontal Reduction
  DEST.fp32[m*2+n] := TMP0.fp32[31:0] + TMP1.fp32[31:0];
RET DEST
```

BHF8FP32Mul represents a scalar multiplication of BF8 and HF8 elements to generate FP32 product. In some embodiments, the source data elements may optionally be converted to larger (e.g., higher-precision) data elements (e.g., 32-bit single-precision floating-point data elements). The operation may also implement floating-point rounding as needed, handle denormals (e.g., whether to FTZ, whether to DAZ) as needed, propagate NaN and infinity as needed.

```
      VMMHBF8PS dest, src1, src2
VL=(128,256,512)
KL=VL/128
FOR i := 0 to KL-1:
  TMP[127:0] := hbf8fp32_2×2×8_matmul(src1.128b[i], src2.128b[i])
  FOR j := 0 to 3:
    dest.fp32[i*4 + j] := dest.fp32[i*4 + j] + TMP.fp32[j]
DEST[MAX_VL-1:VL] := 0
```

Pseudocode Operation hbf8fp32_2×2×8_matmul (src1[127:0], src2[127:0])

```
DEST[127:0] = 0
FOR n := 0 to 1:
  FOR m := 0 to 1:
    P0e.fp32[31:0] := HBF8FP32Mul(src1.hf8[m*8+0], src2.bf8[n*8+0])
    P0o.fp32[31:0] := HBF8FP32Mul(src1.hf8[m*8+1], src2.bf8[n*8+1])
    P1e.fp32[31:0] := HBF8FP32Mul(src1.hf8[m*8+2], src2.bf8[n*8+2])
    P1o.fp32[31:0] := HBF8FP32Mul(src1.hf8[m*8+3], src2.bf8[n*8+3])
    P2e.fp32[31:0] := HBF8FP32Mul(src1.hf8[m*8+4], src2.bf8[n*8+4])
    P2o.fp32[31:0] := HBF8FP32Mul(src1.hf8[m*8+5], src2.bf8[n*8+5])
    P3e.fp32[31:0] := HBF8FP32Mul(src1.hf8[m*8+6], src2.bf8[n*8+6])
    P3o.fp32[31:0] := HBF8FP32Mul(src1.hf8[m*8+7], src2.bf8[n*8+7])
  // Column Horizontal Reductions
  TMP0e.fp32[31:0] := P0e.fp32[31:0] + P0o.fp32[31:0];
  TMP0o.fp32[31:0] := P1e.fp32[31:0] + P1o.fp32[31:0];
  TMP1e.fp32[31:0] := P2e.fp32[31:0] + P2o.fp32[31:0];
  TMP1o.fp32[31:0] := P3e.fp32[31:0] + P3o.fp32[31:0];
  // Vertical Reduction
  TMP0.fp32[31:0] := TMP0e.fp32[31:0] + TMP1e.fp32[31:0];
  TMP1.fp32[31:0] := TMP0o.fp32[31:0] + TMP1o.fp32[31:0];
  // Horizontal Reduction
  DEST.fp32[m*2+n] := TMP0.fp32[31:0] + TMP1.fp32[31:0];
RET DEST
```

HBF8FP32Mul represents a scalar multiplication of HF8 and BF8 elements to generate FP32 product. In some embodiments, the source data elements may optionally be converted to larger (e.g., higher-precision) data elements (e.g., 32-bit single-precision floating-point data elements). The operation may also implement floating-point rounding as needed, handle denormals (e.g., whether to FTZ, whether to DAZ) as needed, propagate NaN and infinity as needed.

It is to be appreciated that, for each of the specific instructions described above, the particular order of accumulation of products of the matrix multiplication and their accumulation with the accumulation value from the source/destination matrix is not required. Each of the specific instructions described above indicates one possible order for such additions/accumulations, but that specific order is only one example and is not required. For each instruction, multiple if not many other orders are also possible. Floating-point additions are not strictly associative. As a result, slightly different results may be achieved when the floating-point additions are performed in different order, which is why one particular example order is specified in the architectural description of these instructions. However, many variations of the instructions are contemplated where the orders are altered in various different ways. By way of example, for the bf8fp32_2×2×78_matmul operation, the illustrated embodiment does column horizontal reductions, vertical reduction, and then horizontal reduction, although this is not required. In other embodiments, many other orders of addition may optionally be used (e.g., P0e.fp32[31:0] may be added with P1e.fp32[31:0] to form a temporary value, P0e.fp32[31:0] may be added with P2e.fp32[31:0] to form a temporary value, P0e.fp32[31:0] may be added with P20.fp32[31:0] to form a temporary value, the temporary values may be added in different order, and so on.

In some embodiments, the accumulation may be performed “late” in that accumulation of the products with the accumulation value and/or the register used to hold the accumulation value is performed only after all multiplications have been performed. In some embodiments, all products are accumulated with the accumulation value after all products have been generated. Another possible approach could be to access the accumulation value and/or the register used to hold the accumulation value sequentially two or more times, including once after one portion (e.g., half) of the multiplications have been performed, and again after another portion (e.g., half) of the multiplications have been performed. Possible advantages of such “late” accumulation is that it may help with latency characteristics and/or improve numerical result quality. Due to late accumulation, only the final result may be exposed to the out-of-order (OoO) machine's scheduler. Also, resetting the running accumulator (e.g., as may be done for late accumulation) may tend to improve the overall result quality as rounding errors (which may be encountered in floating points) may tend to be reduced.

In some embodiments, the processor may have an MXCSR, floating-point control and/or status register, or other register to control floating-point operations. In some embodiments, the register may have one or more fields (e.g., rounding mode field) to specify one of a plurality of supported rounding modes to be used for floating-point operations. In some embodiments, one or more or each of the instructions disclosed above may control that rounding is to be performed according to only a single rounding mode (e.g., a round to nearest even rounding mode in some cases) regardless of and/or irrespective of and/or without checking the one or more fields (e.g., the rounding mode field) in the register. In some such embodiments, the rounding may be performed according to the single rounding mode in a mathematically precise way rather than through a simplification which leads to mathematically imprecise results.

In some embodiments, the MXCSR, floating-point control and/or status register, or other register to control floating-point operations may have one or more fields (e.g., a Flush-To-Zero (FTZ) bit or field) to specify to specify whether denormal results of floating-point operations are to be set, forced, or made to be zero. In some such embodiments, one or more or each of the instructions disclosed above may control or cause the processor to set, force, or make denormal results of floating-point operations are to be to be zero regardless of and/or irrespective of and/or without checking whether the one or more fields (e.g., the FTZ bit or field) in the register specify whether denormal results of floating-point operations are to be set, forced, or made to be zero.

In some embodiments, the MXCSR, floating-point control and/or status register, or other register to control floating-point operations may have one or more fields (e.g., a Denormals-Are-Zero (DAZ) bit or field) to specify whether denormal values in the inputs to floating-point instructions/operations (e.g., the source matrices) are to be set or made to be or treated as zero. In some such embodiments, one or more or each of the instructions disclosed above may control or cause the processor to set or make denormals in the inputs to floating-point operations as zero or treat denormals in the inputs to floating-point operations as zero regardless of and/or irrespective of and/or without checking whether the one or more fields (e.g., the DAZ bit or field) in the register specify whether denormal results of floating-point operations are to be forced to zero. Alternatively, in other embodiments, the instructions that operate on FP16 and FP8 source floating-point data elements (e.g., the VMMF16PS, VMMBF8PS, VMMHF8PS, VMMBHF8PS, and VMMHBF8PS instructions) may optionally respect the DAZ bit or field in the register (e.g., not treat denormal values in inputs to floating-point operations as zero regardless of whether the one or more fields specify that denormal values in inputs to floating-point operations are to be treated as zero). One possible reason for turning off DAZ for FP16 and/or FP8 data element formats is that they have fewer exponent bits (e.g., smaller numeric ranges) such that it may be more appropriate to process denormal values in the inputs/sources rather than setting, making, or treating the denormal values in the inputs/sources as zero.

In some embodiments, the MXCSR, floating-point control and/or status register, or other register to control floating-point operations may have one or more fields to control whether or not floating-point instructions/operations report floating-point exceptions. In some such embodiments, one or more or each of the instructions disclosed above may control or cause the processor to not report floating-point exceptions regardless of and/or irrespective of and/or without checking whether the one or more fields in the register specify whether floating-point exceptions are to be reported. In some embodiments, the instructions may optionally cause the processor to propagate Not-a-Number (NaN) and/or infinity (Inf).

In some such embodiments, one or more or each of the instructions disclosed above may control or cause the processor to complete performance of the operations corresponding to the instruction without accessing (e.g., without reading from and without writing to) the MXCSR, floating-point control and/or status register, or other register to control floating-point operations.

While such floating-point characteristics may not be suitable for all workloads, some workloads may benefit from enhanced performance and/or a simpler implementation that may result from such floating-point characteristics. Strict compliance with floating-point standards and support for all variations of floating-point characteristics often come at a cost. Certain workloads (e.g., artificial intelligence) may not require that all these floating-point characteristics are supported by the instructions and may benefit more from higher performance and/or a simpler implementation.

In some embodiments, one or more or each of the instructions disclosed above may optionally only allow source and destination operands to be in registers not memory, although this is not required. In some embodiments, this may be the case even if the instruction is implemented in an ISA that is not a load-store ISA such that the ISA includes other data processing instructions that are able to specify and operate on operands in memory. By way of example, in the x86 ISA, the instructions may use ModRM:11:rrr:bbb operand addressing mode. One possible reason to do this is to promote improved performance of executing the instruction (e.g., without the latency of memory operand access), which may be more beneficial for certain workloads than the need to access operands in memory. Another possible reason is to reduce the risk of side-channel attacks. However, in other embodiments, source matrices may optionally be allowed to be taken from memory.

In some embodiments, one or more or each of the instructions disclosed above may optionally only be allowed to operate in 64-bit mode (e.g., not in 32-bit mode), although this is not required. Supporting only the 64-bit mode may potentially help to improve performance (e.g., potentially allow access to a greater number of registers, potentially simplify the implementation (e.g., eliminate one or more checks), and so on). However, in other embodiments, the instructions may optionally be supported also in 32-bit mode.

In some embodiments, any one or more of the above-described characteristics may optionally be implicit to the instructions (e.g., implicit to their opcodes) such that the instructions are only able to have these characteristics. In other embodiments, any one or more of the above-described characteristics may optionally be configured or configurable for the instructions (e.g., their opcodes) such that the characteristic(s) may be configured or configurable (e.g., enabled or disabled) for the instructions. In some embodiments, the processor may have one or more bits, flags, or configurable controls (e.g., in a floating-point status and/or control register, in a model specific register (MSR), etc.) to store such configuration information. Each control may have a first value to specify whether the characteristic or an alternate characteristic is to be used. For example, one control may indicate whether the FTZ field is to be respected or overridden by the instruction, etc.

The detailed instructions described above represent specific examples of suitable instructions. However, many modifications to these instructions are possible. For example, the instructions above refer to the xmm, ymm, and zmm registers, which represent registers in the x86 ISA. In other embodiments, these xmm, ymm, and zmm registers may optionally be replaced by other 128-bit, 256-bit, or 512-bit registers in another non-x86 ISA. For example, the xmm, ymm, and zmm registers may optionally be replaced by scalable vector registers Z0-Z31 used in the Scalable Vector Extension (SVE) or SVE2 of the ARM architecture. Thus, other embodiments of the instructions above may broadly use 128-bit, 256-bit, or 512-bit registers or scalable vector registers in place of the xmm, ymm, and zmm registers shown in the examples above. In other embodiments, the instructions may also support different vector register sizes including different numbers of 128-bit lanes (e.g., 640-bit, 768-bit, 1024-bit, etc.). As another example, masking/predication optionally has not been used for these instructions, but in other embodiments masking/predication may optionally be used. As another example, some of the instructions above may use one or more of “ModRM: reg (r,w)”, “ModRM: 11:rrr:bbb”, “VEX.vvvv(r)”, or “ModRM:reg(r)”, which represent operand addressing modes specific to the instruction encoding format used in the x86 ISA. In other embodiments, these operand addressing modes may broadly represent operand addressing modes that may optionally be replaced by other operand addressing modes used by instruction encodings and/or in other non-x86 ISA. Further, the first two set bits “11” of ModRM:11:rrr:bbb designates register/register access in cases where operands are optionally only allowed to be in registers not memory, but this is not required for other embodiments where a source operand may be sourced from memory. As yet another example, some of the instructions above refer to the MXCSR, which is a floating-point status and/or control register in the n x86 ISA. In other embodiments, the MXCSR may optionally be replaced by a floating-point status and/or control register in another non-x86 ISA. Thus, other embodiments of the instructions above may refer to another floating-point status and/or control register.

### EXAMPLES

The following are example implementations of different embodiments of the invention.

Example 1. A processor, comprising: a front end to fetch and decode a plurality of instruction strands to generate a corresponding plurality of microoperations, including matrix processing microoperations; a reservation station to schedule the microoperations for execution in accordance with a first scheduling mode; out-of-order execution circuitry to execute the microoperations; and a detector to determine a density of the matrix processing microoperations within an interval and to signal to the reservation station to implement a second scheduling mode when the density of matrix processing microoperations reaches or exceeds a first threshold.

Example 2. The processor of example 1, wherein the detector is further to determine a density of load microoperations within the interval and is to signal to the reservation station to implement the second scheduling mode only when the density of matrix processing microoperations reaches or exceeds the first threshold and the density of load microoperations reaches or exceeds a second threshold.

Example 3. The processor of examples 1 or 2, wherein the detector comprises a first counter to count the matrix processing microoperations within the interval and a second counter to count the load instructions within the interval.

Example 4. The processor of any of examples 1-3, wherein the density of load microoperations is based on a number of load microoperations which indicate destination vector registers within a register file.

Example 5. The processor of any of examples 1-4, wherein the first scheduling mode comprises prioritizing older uops ahead of younger uops.

Example 6. The processor of any of examples 1-5, wherein the second scheduling mode comprises scheduling younger uops associated with an oldest instruction strand ahead of older uops and then scheduling older uops ahead of younger uops.

Example 7. The processor of any of examples 1-6, wherein the interval comprises a specified number of microoperations or instructions.

Example 8. A method, comprising: fetching and decoding, by a front end of a processor, a plurality of instruction strands to generate a corresponding plurality of microoperations, including matrix processing microoperations; scheduling, by a reservation station of the processor, the microoperations for execution in accordance with a first scheduling mode; executing the microoperations, at least some of the microoperations to be executed out-of-order; determining a density of the matrix processing microoperations within an interval; and scheduling, by the reservation station, the microoperations for execution in accordance with a second scheduling mode when the density of matrix processing microoperations reaches or exceeds a first threshold.

Example 9. The method of example 8, further comprising: determining a density of load microoperations within the interval; scheduling, by the reservation station, the microoperations for execution in accordance with the second scheduling mode when only when the density of matrix processing microoperations reaches or exceeds the first threshold and the density of load microoperations reaches or exceeds a second threshold.

Example 10. The method of examples 8 or 9, wherein determining the density of the matrix processing microoperations and the density of load microoperations within the interval comprises incrementing a first counter to count the matrix processing microoperations within the interval and incrementing a second counter to count the load instructions within the interval.

Example 11. The method of any of examples 8-10, wherein the density of load microoperations is based on a number of load microoperations which indicate destination vector registers within a register file.

Example 12. The method of any of examples 8-11, wherein the first scheduling mode comprises prioritizing older uops ahead of younger uops.

Example 13. The method of any of examples 8-12, wherein the second scheduling mode comprises scheduling younger uops associated with an oldest instruction strand ahead of older uops and then scheduling older uops ahead of younger uops.

Example 14. The method of any of examples 8-13, wherein the interval comprises a specified number of microoperations or instructions.

Example 15. A machine-readable medium having program code stored thereon which, when executed by a machine, causes the machine to perform additional operations, comprising: fetching and decoding, by a front end of a processor, a plurality of instruction strands to generate a corresponding plurality of microoperations, including matrix processing microoperations; scheduling, by a reservation station of the processor, the microoperations for execution in accordance with a first scheduling mode; executing the microoperations, at least some of the microoperations to be executed out-of-order; determining a density of the matrix processing microoperations within an interval; and scheduling, by the reservation station, the microoperations for execution in accordance with a second scheduling mode when the density of matrix processing microoperations reaches or exceeds a first threshold.

Example 16. The machine-readable medium of example 15, further comprising: determining a density of load microoperations within the interval; scheduling, by the reservation station, the microoperations for execution in accordance with the second scheduling mode when only when the density of matrix processing microoperations reaches or exceeds the first threshold and the density of load microoperations reaches or exceeds a second threshold.

Example 17. The machine-readable medium of examples 15 or 16, wherein determining the density of the matrix processing microoperations and the density of load microoperations within the interval comprises incrementing a first counter to count the matrix processing microoperations within the interval and incrementing a second counter to count the load instructions within the interval.

Example 18. The machine-readable medium of any of examples 15-17, wherein the density of load microoperations is based on a number of load microoperations which indicate destination vector registers within a register file.

Example 19. The machine-readable medium of any of examples 15-18, wherein the first scheduling mode comprises prioritizing older uops ahead of younger uops.

Example 20. The machine-readable medium of any of examples 15-19, wherein the second scheduling mode comprises scheduling younger uops associated with an oldest instruction strand ahead of older uops and then scheduling older uops ahead of younger uops.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals-such as carrier waves, infrared signals, digital signals, etc.).

In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. A processor, comprising:
a front end to fetch and decode a plurality of instruction strands to generate a corresponding plurality of microoperations, including matrix processing microoperations;
a reservation station to schedule the microoperations for execution in accordance with a first scheduling mode;
out-of-order execution circuitry to execute the microoperations; and
a detector to determine a density of the matrix processing microoperations within an interval and to signal to the reservation station to implement a second scheduling mode when the density of matrix processing microoperations reaches or exceeds a first threshold.

2. The processor of claim 1, wherein the detector is further to determine a density of load microoperations within the interval and is to signal to the reservation station to implement the second scheduling mode only when the density of matrix processing microoperations reaches or exceeds the first threshold and the density of load microoperations reaches or exceeds a second threshold.

3. The processor of claim 2, wherein the detector comprises a first counter to count the matrix processing microoperations within the interval and a second counter to count the load instructions within the interval.

4. The processor of claim 3, wherein the density of load microoperations is based on a number of load microoperations which indicate destination vector registers within a register file.

5. The processor of claim 1, wherein the first scheduling mode comprises prioritizing older uops ahead of younger uops.

6. The processor of claim 5, wherein the second scheduling mode comprises scheduling younger uops associated with an oldest instruction strand ahead of older uops and then scheduling older uops ahead of younger uops.

7. The processor of claim 1, wherein the interval comprises a specified number of microoperations or instructions.

8. A method, comprising:
fetching and decoding, by a front end of a processor, a plurality of instruction strands to generate a corresponding plurality of microoperations, including matrix processing microoperations;
scheduling, by a reservation station of the processor, the microoperations for execution in accordance with a first scheduling mode;
executing the microoperations, at least some of the microoperations to be executed out-of-order;
determining a density of the matrix processing microoperations within an interval; and
scheduling, by the reservation station, the microoperations for execution in accordance with a second scheduling mode when the density of matrix processing microoperations reaches or exceeds a first threshold.

9. The method of claim 8, further comprising:
determining a density of load microoperations within the interval;
scheduling, by the reservation station, the microoperations for execution in accordance with the second scheduling mode when only when the density of matrix processing microoperations reaches or exceeds the first threshold and the density of load microoperations reaches or exceeds a second threshold.

10. The method of claim 9, wherein determining the density of the matrix processing microoperations and the density of load microoperations within the interval comprises incrementing a first counter to count the matrix processing microoperations within the interval and incrementing a second counter to count the load instructions within the interval.

11. The method of claim 10, wherein the density of load microoperations is based on a number of load microoperations which indicate destination vector registers within a register file.

12. The method of claim 8, wherein the first scheduling mode comprises prioritizing older uops ahead of younger uops.

13. The method of claim 12, wherein the second scheduling mode comprises scheduling younger uops associated with an oldest instruction strand ahead of older uops and then scheduling older uops ahead of younger uops.

14. The method of claim 8, wherein the interval comprises a specified number of microoperations or instructions.

15. A machine-readable medium having program code stored thereon which, when executed by a machine, causes the machine to perform additional operations, comprising:
fetching and decoding, by a front end of a processor, a plurality of instruction strands to generate a corresponding plurality of microoperations, including matrix processing microoperations;
scheduling, by a reservation station of the processor, the microoperations for execution in accordance with a first scheduling mode;
executing the microoperations, at least some of the microoperations to be executed out-of-order;
determining a density of the matrix processing microoperations within an interval; and
scheduling, by the reservation station, the microoperations for execution in accordance with a second scheduling mode when the density of matrix processing microoperations reaches or exceeds a first threshold.

16. The machine-readable medium of claim 15, further comprising:
determining a density of load microoperations within the interval;
scheduling, by the reservation station, the microoperations for execution in accordance with the second scheduling mode when only when the density of matrix processing microoperations reaches or exceeds the first threshold and the density of load microoperations reaches or exceeds a second threshold.

17. The machine-readable medium of claim 16, wherein determining the density of the matrix processing microoperations and the density of load microoperations within the interval comprises incrementing a first counter to count the matrix processing microoperations within the interval and incrementing a second counter to count the load instructions within the interval.

18. The machine-readable medium of claim 17, wherein the density of load microoperations is based on a number of load microoperations which indicate destination vector registers within a register file.

19. The machine-readable medium of claim 15, wherein the first scheduling mode comprises prioritizing older uops ahead of younger uops.

20. The machine-readable medium of claim 19, wherein the second scheduling mode comprises scheduling younger uops associated with an oldest instruction strand ahead of older uops and then scheduling older uops ahead of younger uops.
